(19) United States
(12) Patent Application Publication
(10) Pub. No.: US 2025/0264856 A1
(43) Pub. Date: Aug. 21, 2025

(54) COMPUTING DEVICE, MACHINE TOOL, CONTROL DEVICE FOR MACHINE TOOL, AND STORAGE MEDIUM

(71) Applicant: FANUC CORPORATION, Minamitsuru-gun, Yamanashi (JP)

(72) Inventor: Yuutarou MOMOSAKI, Minamitsuru-gun, Yamanashi-ken (JP)

(73) Assignee: FANUC CORPORATION, Minamitsuru-gun, Yamanashi (JP)

(21) Appl. No.: 18/858,011

(22) PCT Filed: Apr. 28, 2022
(86) PCT No.: PCT/JP2022/019436

§ 371 Date: Oct. 18, 2024

(51) Int. Cl. G05B 19/402

(52) U.S. Cl. CPC G05B 19/402; G05B 2219/36201; G05B 2219/49178

(57) ABSTRACT

A computing device computes a position of a tool that cuts a ridge line formed by a peripheral wall face and a cylinder peripheral face forming a through hole, having the shape of a column, penetrating through a workpiece. The computing device calculates the position on the basis of: a first basis vector and a second basis vector on a plane perpendicular to a tangent to the ridge line; workpiece data; an ellipse formed by the plane and the column; a predetermined processing width; and a radius of the tool.

### TECHNICAL FIELD

The present invention relates to a computation device (computing device), a machine tool, a control device for a machine tool, and a computation program (computing program).

### BACKGROUND ART

In WO 2016/133162 A1, a tool path calculation program is disclosed. By such a path calculation program, it is possible to calculate a path for a tool for removing burrs (deburring) from a workpiece (an object to be machined).

### SUMMARY OF THE INVENTION

In WO 2016/133162 A1, two methods are disclosed for the purpose of calculating a machining depth in relation to removal of the burrs or chamfering the workpiece. According to the method disclosed as a “first method,” a chamfering width becomes smaller. Therefore, the “first method” is not accurate. According to the method disclosed as a “second method,” a Newton's method is used in order to determine a solution. Therefore, the “second method” as well is not accurate.

In accordance with these methods, there is a problem in that they are incapable of calculating an accurate position of the tool that realizes a stable cutting process (machining). By cutting that is performed using a tool that has been moved to a calculated position, there is a concern that the workpiece will be cut (machined) either insufficiently or excessively.

The present invention has the object of solving the aforementioned problem.

A first aspect of the present invention is characterized by a computation device configured to calculate a first position of a tool configured to cut a ridge line at a predetermined machining width, the ridge line being formed by a cylindrical circumferential surface of a workpiece and a circumferential wall surface that defines a through hole penetrating through the workpiece, wherein the workpiece includes an outer circumferential surface and an inner circumferential surface, at least one of the outer circumferential surface or the inner circumferential surface being formed as the cylindrical circumferential surface, and the through hole penetrates, in a shape of a circular cylinder or a columnar body, through the workpiece from one to another of the outer circumferential surface and the inner circumferential surface, the columnar body containing a plurality of the circular cylinders that are parallel to each other and that are disposed respectively in corners of the columnar body, the computation device including: an acquisition unit configured to acquire machining target data and a third radius of the tool, the machining target data including a second position of the workpiece, a third position of the through hole, a first radius of the cylindrical circumferential surface of the workpiece, a second radius of the circular cylinder, a first direction in which a first central axial line of the workpiece extends, and an eccentric distance of a second central axial line of the circular cylinder from the first central axial line, the second central axial line extending in a second direction perpendicular to the first direction; a first computation unit configured to calculate a first basis vector and a second basis vector, based on the machining target data, wherein the first basis vector is a vector on a plane and perpendicular to the second central axial line, and has, as a starting point, a machining target point that is on the ridge line, and the second basis vector is a vector on the plane and perpendicular to the first basis vector, and has the machining target point as a starting point, and wherein the plane is perpendicular to a tangent line to the ridge line at the machining target point, the plane includes the machining target point, and the plane is determined based on a fourth position of the machining target point and the machining target data; and a second computation unit configured to calculate the first position of the tool that cuts the ridge line including the machining target point, based on the machining target data, an ellipse formed by the plane and the circular cylinder and determined based on the machining target data, the predetermined machining width, the third radius of the tool, the first basis vector, and the second basis vector.

A second aspect of the present invention is characterized by a machine tool including the computation device according to the first aspect, the tool, and a machining control unit configured to cause the tool to move to the first position and cause the tool to cut the ridge line.

A third aspect of the present invention is characterized by a control device for a machine tool, including the computation device according to the first aspect, and a machining control unit configured to cause the tool to move to the first position and cause the tool to cut the ridge line.

A fourth aspect of the present invention is characterized by a computation program configured to cause a processing circuit included in a computation device, to perform an acquisition step, a first computation step, and a second computation step, wherein: the computation device is configured to calculate a first position of a tool configured to cut a ridge line at a predetermined machining width, the ridge line being formed by a cylindrical circumferential surface of a workpiece and a circumferential wall surface that defines a through hole penetrating through the workpiece; the workpiece includes an outer circumferential surface and an inner circumferential surface, at least one of the outer circumferential surface or the inner circumferential surface being formed as the cylindrical circumferential surface; and the through hole penetrates, in a shape of a circular cylinder or a columnar body, through the workpiece from one to another of the outer circumferential surface and the inner circumferential surface, the columnar body containing a plurality of the circular cylinders that are parallel to each other and that are disposed respectively in corners of the columnar body, and wherein: the acquisition step includes acquiring machining target data and a third radius of the tool, the machining target data including a second position of the workpiece, a third position of the through hole, a first radius of the cylindrical circumferential surface of the workpiece, a second radius of the circular cylinder, a first direction in which a first central axial line of the workpiece extends, and an eccentric distance of a second central axial line of the circular cylinder from the first central axial line, the second central axial line extending in a second direction perpendicular to the first direction; the first computation step includes calculating a first basis vector and a second basis vector, based on the machining target data, wherein the first basis vector is a vector on a plane and perpendicular to the second central axial line, and has, as a starting point, a machining target point that is on the ridge line, and the second basis vector is a vector on the plane and perpendicular to the first basis vector, and has the machining target point as a starting point, and wherein the plane is perpendicular to a tangent line to the ridge line at the machining target point, the plane includes the machining target point, and the plane is determined based on a fourth position of the machining target point and the machining target data; and the second computation step includes calculating the first position of the tool that cuts the ridge line including the machining target point, based on the machining target data, an ellipse formed by the plane and the circular cylinder and determined based on the machining target data, the predetermined machining width, the third radius of the tool, the first basis vector, and the second basis vector.

According to the present invention, it is possible to accurately calculate the position of a tool that realizes a stable cutting process for the purpose of removing burrs.

### BRIEF DESCRIPTION OF DRAWINGS

FIG. 1 is a diagram showing an example of a machine tool;

FIG. 2A is a diagram illustrating an example of a configuration of a control device for a machine tool, and FIG. 2B is a diagram for the purpose of describing processing performed based on a G-code;

FIG. 3A and FIG. 3B are diagrams for the purpose of describing a thick-walled cylinder, and a through hole that is formed in the thick-walled cylinder;

FIG. 4A is a diagram showing a burr that is generated on an inner circumferential surface of the thick-walled cylinder, and a tool for removing such a burr, and FIG. 4B is a diagram showing a burr that is generated on an outer circumferential surface of the thick-walled cylinder, and a tool for removing such a burr;

FIG. 5A is a diagram showing a positional relationship, in a case in which an eccentric distance is zero, between a first central axial line of the thick-walled cylinder, and a second central axial line of a circular cylinder that forms the through hole, and FIG. 5B is a diagram showing a positional relationship, in a case in which the eccentric distance is not zero, between the first central axial line of the thick-walled cylinder and the second central axial line of a circular cylinder that forms the through hole;

FIG. 6 is a diagram illustrating data acquired by an acquisition unit of a computation device;

FIG. 7A is a diagram for the purpose of describing a relationship between an amount of cutting and a predetermined machining width, and FIG. 7B and FIG. 7C are diagrams for the purpose of describing a tolerance amount;

FIG. 8 is a diagram for the purpose of describing a through hole that penetrates, in the shape of a circular cylinder, through the thick-walled cylinder, and a tangent line to a ridge line of the through hole;

FIG. 9 is a diagram for the purpose of describing a vertical plane perpendicular to the tangent line to the ridge line of the through hole, and a first ellipse and a second ellipse that are formed on the vertical plane;

FIG. 10A is a diagram showing an angle formed by a perpendicular line from a machining target point on the ridge line of the through hole to the first central axial line of the thick-walled cylinder with respect to the X-axis, and FIG. 10B is a diagram showing an angle formed with respect to the X-axis by a perpendicular line from the machining target point on the ridge line of the through hole to a second central axial line of the circular cylinder that forms the shape of the through hole, and a first basis vector;

FIG. 11 is a diagram showing a first position of a tool for removing the burr that is generated on the inner circumferential surface of the thick-walled cylinder, as well as the first basis vector and a second basis vector;

FIG. 12 is a diagram for the purpose of describing how a first position of the tool corresponding to a machining target point on a ridge line of the through hole is calculated based on the predetermined machining width;

FIG. 13 is a diagram showing a first position of a tool for removing the burr that is generated on the outer circumferential surface of the thick-walled cylinder, as well as the first basis vector and the second basis vector;

FIG. 14 is a diagram for the purpose of describing how a first position of the tool corresponding to a machining target point on a ridge line of the through hole is calculated based on the predetermined machining width;

FIG. 15 is a flowchart showing a processing procedure executed by a control device of the machine tool;

FIG. 16 is a diagram illustrating a computer program product of a computation program for causing a computation device of the control device to execute the processing procedure shown in FIG. 15;

FIG. 17 is a diagram illustrating a manifold block that is used as an object to be machined;

FIG. 18 is a diagram for the purpose of describing the thick-walled cylinder, and a through hole having an elongated hole shape that penetrates through the thick-walled cylinder;

FIG. 19 is a diagram schematically showing the through hole having the elongated hole shape;

FIG. 20 is a diagram for the purpose of describing the thick-walled cylinder and a through hole having a rounded rectangular shape that penetrates through the thick-walled cylinder;

FIG. 21 is a diagram schematically illustrating the through hole having the rounded rectangular shape; and

FIG. 22 is a diagram for the purpose of describing a positional relationship between a first position of the tool and a first central axial line of the thick-walled cylinder.

### DETAILED DESCRIPTION OF THE INVENTION

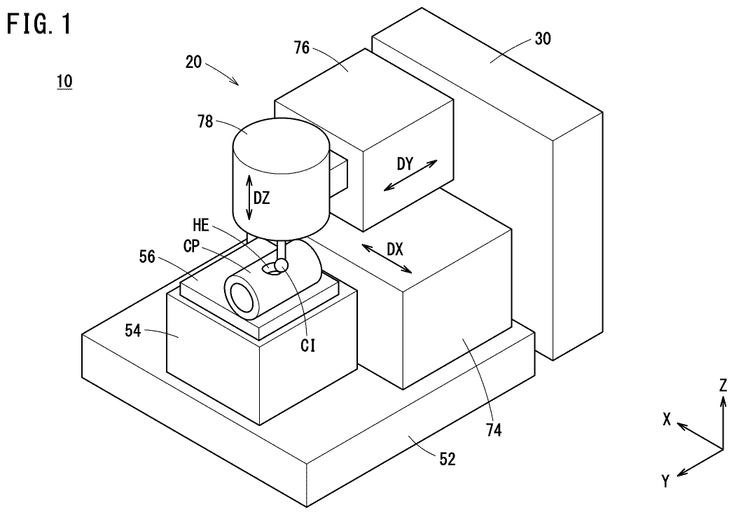

FIG. 1 is a diagram showing an example of a machine tool 10. The machine tool 10 includes a main body 20 and a control device 30. The control device 30 includes a computation device according to an embodiment described below, and controls the main body 20. The control device 30, for example, is a CNC (computer numerical controller). The main body 20 includes a bed 52, a saddle 54, a table 56, a movable member 74, a movable member 76, and a movable member 78. The bed 52 is placed on an XY plane of an orthogonal coordinate system XYZ. The saddle 54, the table 56, the movable member 74, the movable member 76, and the movable member 78 are placed on the bed 52.

The movable member 74 is capable of being moved by a non-illustrated motor in a direction DX that is parallel to the X-axis. The movable member 76 is placed on the movable member 74. The movable member 76 is capable of being moved with respect to the movable member 74 by a non-illustrated motor in a direction DY that is parallel to the Y-axis. The movable member 78 is installed on a side surface of the movable member 76. The movable member 78 is capable of being moved with respect to the movable member 76 by a non-illustrated motor in a direction DZ that is parallel to the Z-axis. The direction DZ that is parallel to the Z-axis is parallel to the direction of gravity. The direction of gravity is the direction in which gravity acts on an object.

The movable member 78 includes a spindle head. A tool CI is installed on the spindle head. In the present embodiment, the tool CI is a ball end mill having a spherical cutting surface formed on a distal end thereof. The tool CI may also be another tool, for example, such as a polishing tool of a ball head or the like. Furthermore, the tool CI is not limited to having a completely spherical cutting surface, but may include a cutting surface that is formed by a portion of a spherical shape.

In the present embodiment, a thick-walled cylinder CP is placed on the table 56 as a workpiece (an object to be machined). The tool CI is driven by a non-illustrated motor, and thereby rotates. By undergoing rotation in such a manner, the tool CI cuts (machines), with the spherical cutting surface, a ridge line that forms an edge of a through hole HE possessed by the thick-walled cylinder CP. The tool CI, by cutting the ridge line, removes burrs that are formed on an inner circumferential surface or an outer circumferential surface of the thick-walled cylinder CP.

In the present embodiment, during cutting, the tool CI is moved in an XYZ space by the movable member 74, the movable member 76, and the movable member 78. Stated otherwise, by the tool CI being moved in the direction DX parallel to the X-axis, the direction DY parallel to the Y-axis, and the direction DZ parallel to the Z-axis, the tool CI moves relatively with respect to the workpiece in an X-axis direction, a Y-axis direction, and a Z-axis direction.

Moreover, since the tool CI only needs to move relatively with respect to the workpiece in the X-axis direction, the Y-axis direction, and the Z-axis direction, the tool CI may be moved in the direction DZ that is parallel to the Z-axis, and the workpiece may be moved in the direction DX that is parallel to the X-axis, and in the direction DY that is parallel to the Y-axis. In that case, for example, movable mechanisms are provided in the saddle 54 and the table 56.

Instead of the movable member 74, the movable member 76, and the movable member 78, a robot arm may grip the tool CI. Alternatively, the workpiece, which is gripped by the robot arm, may move in the X-axis direction, the Y-axis direction, and the Z-axis direction. In either of these cases, the tool CI moves relatively with respect to the workpiece in the X-axis direction, the Y-axis direction, and the Z-axis direction. In the following description, the tool CI moves relatively with respect to the thick-walled cylinder CP which serves as the workpiece.

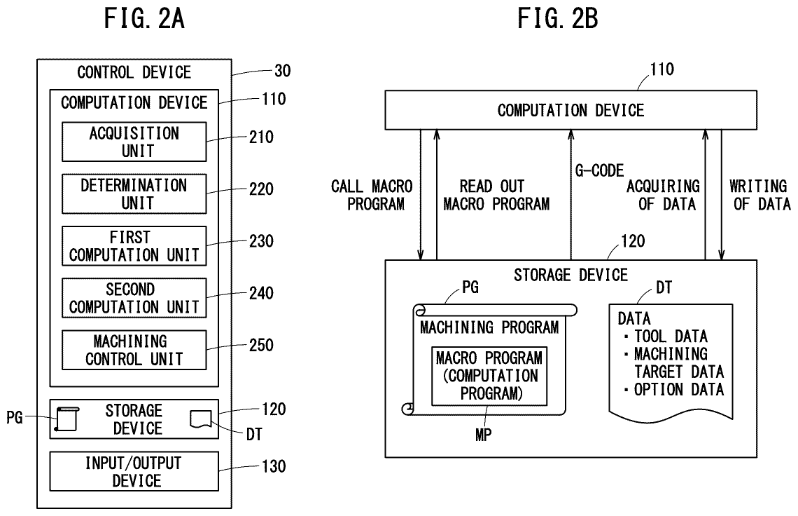

FIG. 2A is a diagram illustrating an example of a configuration of the control device 30 for the machine tool 10. The control device 30 includes a computation device 110, a storage device 120, and an input/output device 130. The computation device 110 is constituted by a processing circuit. The processing circuit, for example, is a processor such as a CPU or a GPU or the like.

The storage device 120 includes a non-illustrated volatile memory, and a non-illustrated non-volatile memory. The volatile memory is used as a working memory of the processor. In the volatile memory, later-described data DT acquired by an acquisition unit 210 is stored when a macro program to be described later is read out. The volatile memory, for example, is a RAM.

The non-volatile memory is used as a storage memory. A machining program PG and a computation program (a macro program) to be executed by the processing circuit of the computation device 110 are stored in the non-volatile memory of the storage device 120. The non-volatile memory, for example, is a ROM or a flash memory.

The input/output device 130 includes at least one component from among, for example, an operation panel, a keyboard, a mouse, a display, and a touch panel. The user inputs user input data from among the data DT to the computation device 110 via the input/output device 130. The data DT that is input is stored in the storage device 120. Furthermore, setting data of default setting values from among the data DT is also stored in the storage device 120. The input/output device 130 is capable of displaying the data DT that is stored in the storage device 120.

The computation device 110 includes the acquisition unit 210, a determination unit 220, a first computation unit 230, a second computation unit 240, and a machining control unit 250. The acquisition unit 210, the determination unit 220, the first computation unit 230, the second computation unit 240, and the machining control unit 250 are realized by the computation device 110 executing the computation program that is stored in the storage device 120. At least part of the acquisition unit 210, the determination unit 220, the first computation unit 230, the second computation unit 240, and the machining control unit 250 may be realized by an integrated circuit such as an ASIC or an FPGA, or an electronic circuit including a discrete device.

The acquisition unit 210 acquires the data DT that is input by the user, and the data DT that is stored in the storage device 120. The data DT that is acquired by the acquisition unit 210 includes tool data, machining target data, and option data, all of which will be described later.

As noted previously, in order to remove the burrs, the tool CI cuts (machines) the ridge line that forms the edge of the through hole HE. The position of the tool CI is calculated corresponding to a machining target point on the ridge line of the through hole HE. The calculated position of the tool CI will hereinafter be referred to as a first position. The machining target point is positioned on the ridge line of the through hole HE at a position that becomes closest in proximity to the first position of the tool CI. The determination unit 220 determines a plurality of the machining target points on the ridge line, on the basis of a tolerance amount included in the aforementioned option data. A description will be given later concerning the tolerance amount.

The first computation unit 230 calculates a first basis vector and a second basis vector based on the data DT acquired by the acquisition unit 210. The first basis vector and the second basis vector will be described in detail later. The second computation unit 240 calculates the first position of the tool CI corresponding to each of the machining target points determined by the determination unit 220, based on the first basis vector and the second basis vector, and the data DT acquired by the acquisition unit 210.

The machining control unit 250, at each of the plurality of machining target points determined by the determination unit 220, controls the movable member 74, the movable member 76, and the movable member 78 of the main body 20, or alternatively, other movable mechanisms or robot arms, and thereby causes the tool CI to move relatively to the first position. The machining control unit 250 causes the tool CI to rotate, and thereby causes the ridge line to be cut by the tool CI.

In order to start cutting the ridge line at the first (initial) machining target point from among the plurality of machining target points determined by the determination unit 220, the tool CI moves to a first position corresponding to that machining target point that was calculated by the second computation unit 240. The ridge line is cut to thereby form a machining surface of a predetermined machining width. Thereafter, the tool CI moves toward a next machining target point while cutting the ridge line, and moves to a first position corresponding to such a machining target point. The ridge line is cut to thereby form a machining surface of a predetermined machining width. After such cutting has been repeated, when the tool CI returns to the first (initial) machining target point, the machining control unit 250 stops the cutting, and causes the tool CI to move to a predetermined end position.

FIG. 2B is a diagram for the purpose of describing processing performed based on a G-code. In the present embodiment, a machining program PG is executed, in accordance with a user input, by the processing circuit of the computation device 110. When the machining program PG is executed, processing is executed on the basis of the G-code that is included in the machining program PG. In the machining program PG, the G-code is included which indicates a command for calling a macro program MP.

Based on the G-code, the processing circuit of the computation device 110 calls the macro program MP that is stored in the non-volatile memory of the storage device 120. Together therewith, the processing circuit of the computation device 110 writes into the volatile memory of the storage device 120 the data DT, which is of a value corresponding to an argument of the G-code or is a default value. The data DT includes tool data, machining target data, and option data, all of which will be described later.

The second computation unit 240 of the computation device 110 reads out, as the computation program, the macro program MP that is a target for being called, from the storage device 120. The acquisition unit 210 of the computation device 110 acquires the data DT from the storage device 120. Using the data DT, the processing circuit of the computation device 110 executes the macro program MP, whereby the second computation unit 240 calculates the first position of the tool CI.

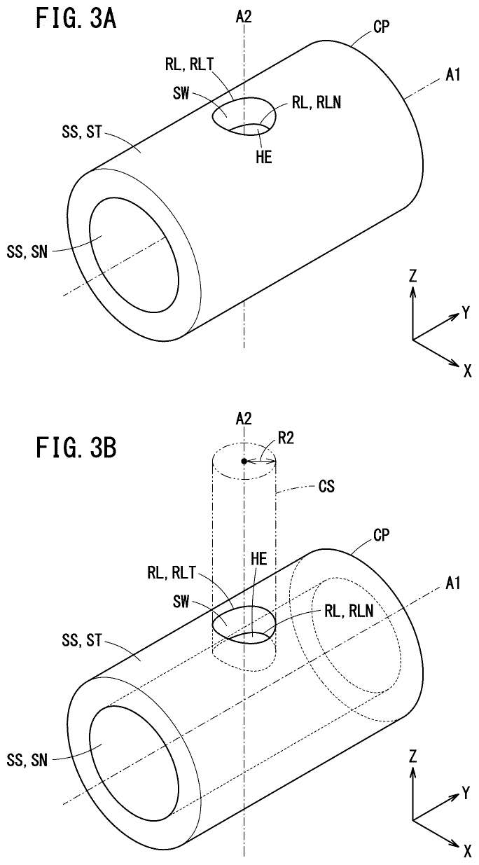

FIG. 3A and FIG. 3B are diagrams for the purpose of describing the thick-walled cylinder CP, and the through hole HE that is formed in the thick-walled cylinder CP. FIG. 3A is a view of the thick-walled cylinder CP as viewed from the exterior. In that case, lines which are not visible from the exterior are not shown in FIG. 3A. FIG. 3B is a figure in which such lines that are incapable of being seen are visibly shown as dashed lines.

Hereinafter, the central axial line of the thick-walled cylinder CP will be referred to as a first central axial line A1. The direction in which the first central axial line A1 of the thick-walled cylinder CP extends will hereinafter be referred to as a first direction. In the present embodiment, the first direction in which the first central axial line A1 of the thick-walled cylinder CP extends is the Y-axis direction. Alternatively, it should be noted that the first direction may be a direction that is parallel to the XY plane, and which forms a predetermined angle with respect to the Y-axis on a plane that includes the first central axial line A1. The thick-walled cylinder CP is a hollow cylinder. An inner circumferential surface SN and an outer circumferential surface ST of the thick-walled cylinder CP are each formed as a cylindrical circumferential surface SS.

In the present embodiment, the through hole HE, which penetrates, in the shape of a circular cylinder CS, through the thick-walled cylinder CP from the outer circumferential surface ST to the inner circumferential surface SN of the thick-walled cylinder CP, is defined by a circumferential wall surface SW. The ridge line RL forming an edge of the through hole HE includes two types of ridge lines RLN and RLT. The ridge line RLN is formed by the circumferential wall surface SW of the through hole HE, and the inner circumferential surface SN of the thick-walled cylinder CP. The ridge line RLT is formed by the circumferential wall surface SW of the through hole HE, and the outer circumferential surface ST of the thick-walled cylinder CP.

The central axial line of the circular cylinder CS that defines the through hole HE will hereinafter be referred to as a second central axial line A2. The direction in which the second central axial line A2 extends is hereinafter referred to as a second direction. In the present embodiment, the second direction in which the second central axial line A2 extends is the Z-axis direction. More specifically, the second direction in which the second central axial line A2 extends is perpendicular to the first direction in which the first central axial line A1 extends. The radius of an imaginary circular cylinder CS that defines the shape of the through hole HE will hereinafter be referred to as a second radius R2.

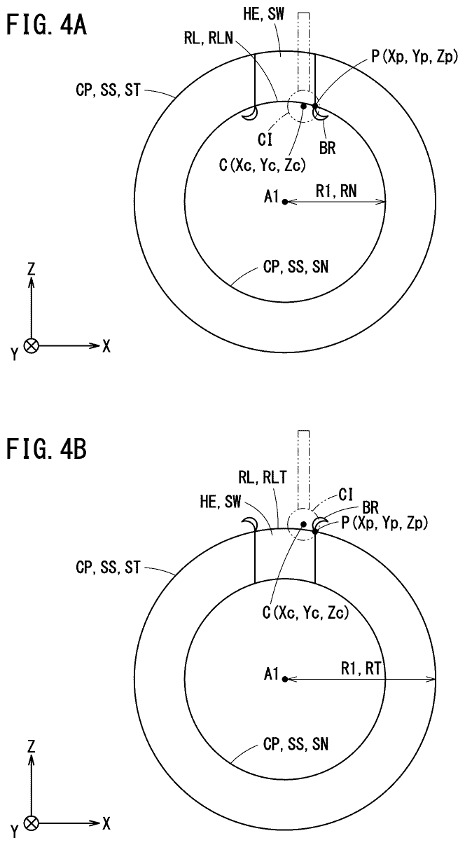

FIG. 4A is a diagram showing a burr BR generated on the inner circumferential surface SN of the thick-walled cylinder CP, and a tool CI for removing such a burr BR. In FIG. 4A, a case is shown in which the thick-walled cylinder CP, which is cut by a plane perpendicular to the Y-axis (a plane parallel to the XZ plane), is viewed from the negative direction of the Y-axis. When the tool CI comes into contact with the ridge line RL (RLN), the tool CI removes the burr BR by cutting, at a predetermined machining width, the ridge line RL including the machining target point P. It is necessary to appropriately determine a first position C of the tool CI at which it is possible to cut the ridge line RL at the predetermined machining width. The first position C of the tool CI is a center position of a sphere that forms the cutting surface of a distal end of the tool CI.

The radius of the cylindrical circumferential surface SS of the thick-walled cylinder CP will hereinafter be referred to as a first radius R1. As shown in FIG. 4A, in the case that the burr BR generated on the inner circumferential surface SN of the thick-walled cylinder CP is removed, the radius RN of the inner circumferential surface SN is used as the first radius R1 of the cylindrical circumferential surface SS of the thick-walled cylinder CP. The radius RN of the inner circumferential surface SN is equal to a shortest distance between the first central axial line A1 of the thick-walled cylinder CP and the inner circumferential surface SN.

FIG. 4B is a diagram showing the burr BR that is generated on the outer circumferential surface ST of the thick-walled cylinder CP, and the tool CI for removing such a burr BR. In the same manner as in FIG. 4A, in FIG. 4B, a case is shown in which the thick-walled cylinder CP, which is cut by a plane perpendicular to the Y-axis (a plane parallel to the XZ plane), is viewed from the negative direction of the Y-axis. When the tool CI comes into contact with the ridge line RL (RLT), the tool CI removes the burr BR by cutting, at a predetermined machining width, the ridge line RL including the machining target point P. It is necessary to appropriately determine the first position C of the tool CI at which it is possible to cut the ridge line RL at the predetermined machining width.

As shown in FIG. 4B, in the case that the burr BR generated on the outer circumferential surface ST of the thick-walled cylinder CP is removed, the radius RT of the outer circumferential surface ST is used as the first radius R1 of the cylindrical circumferential surface SS of the thick-walled cylinder CP. The radius RT of the outer circumferential surface ST is equal to a shortest distance between the first central axial line A1 of the thick-walled cylinder CP and the outer circumferential surface ST.

In FIG. 4A and FIG. 4B, the tool CI is depicted as approaching from an outer side of the thick-walled cylinder CP toward the first position C. However, the tool CI may approach from an inner side of the thick-walled cylinder CP toward the first position C.

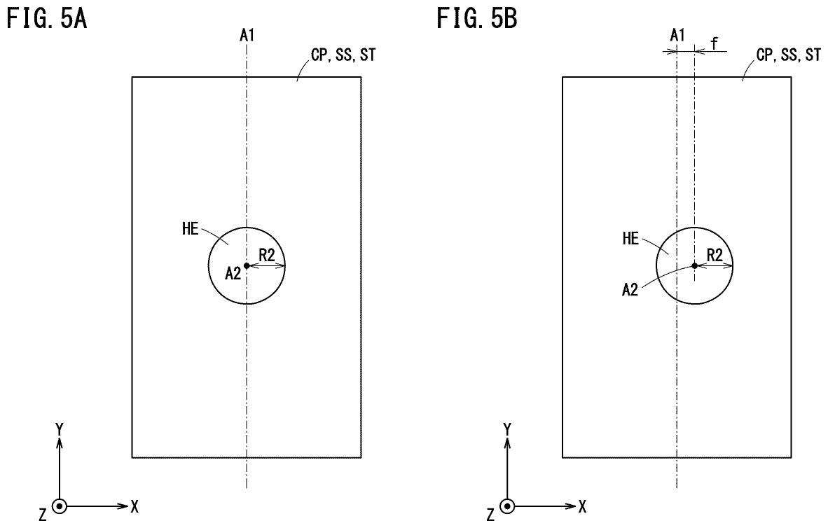

FIG. 5A is a diagram showing a positional relationship, in a case in which an eccentric distance f is zero, between the first central axial line A1 of the thick-walled cylinder CP and the second central axial line A2 of the circular cylinder CS that forms the through hole HE. The eccentric distance indicates a shortest distance of the second central axial line A2 from the first central axial line A1. In FIG. 5A, a case is shown in which the thick-walled cylinder CP having the through hole HE is viewed from a positive direction of the Z-axis on the outer side of the thick-walled cylinder CP.

A bottom surface of the circular cylinder CS that forms the shape of the through hole HE is circular. Therefore, in the case that the through hole HE is viewed from directly above the through hole HE along the Z-axis, the through hole HE is of a circular shape corresponding to the circular cylinder CS. The second central axial line A2 is positioned in an overlapping manner on the first central axial line A1. A radius of the through hole HE when viewed from directly above coincides with the second radius R2 of the circular cylinder CS.

FIG. 5B is a diagram showing a positional relationship, in a case in which the eccentric distance f is not zero, between the first central axial line A1 of the thick-walled cylinder CP and the second central axial line A2 of the circular cylinder CS that forms the through hole HE. In the same manner as in FIG. 5A, in FIG. 5B, a case is shown in which the thick-walled cylinder CP having the through hole HE is viewed from a positive direction of the Z-axis on the outer side of the thick-walled cylinder CP. In the same manner as in FIG. 5A, in the case that the through hole HE is viewed from directly above the through hole HE along the Z-axis, the through hole HE is of a circular shape. The second central axial line A2 is at a position that is offset (deviated) by the eccentric distance f in the X-axis direction from the first central axial line A1.

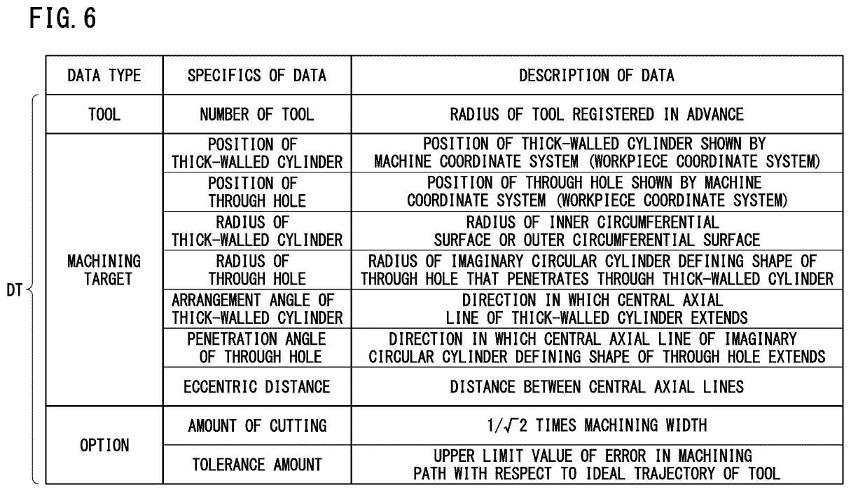

FIG. 6 is a diagram illustrating the data DT acquired by the acquisition unit 210 of the computation device 110. The data DT that is acquired by the acquisition unit 210 includes the tool data, the machining target data, and the option data. The tool data includes a number of the tool CI that is stored in the storage device 120. A value of the radius of the tool CI is stored in the storage device 120 in association with the number of the tool CI. When the number of a tool CI is designated by the user via the input/output device 130, then the acquisition unit 210 acquires the tool data, to thereby acquire, from the storage device 120, the radius of the tool CI that has been registered in advance. Moreover, the radius of the tool CI will hereinafter be referred to as a third radius.

The machining target data includes a position of the thick-walled cylinder CP, a position of the through hole HE, the first radius R1 of the cylindrical circumferential surface SS of the thick-walled cylinder CP, the second radius R2 of the imaginary circular cylinder CS that forms the shape of the through hole HE, an arrangement angle of the thick-walled cylinder CP, a penetration angle of the through hole HE, and the aforementioned eccentric distance f. The thick-walled cylinder CP and the through hole HE are positioned respectively at predetermined positions. The position of the thick-walled cylinder CP will hereinafter be referred to as a second position. The position of the through hole HE will hereinafter be referred to as a third position. The second position of the thick-walled cylinder CP and the third position of the through hole HE are expressed in a machine coordinate system predefined in the machine tool 10, or alternatively, in a workpiece coordinate system based on the workpiece.

The arrangement angle of the thick-walled cylinder CP is an angle that the first direction in which the first central axial line A1 of the thick-walled cylinder CP extends forms with respect to the Y-axis. In the present embodiment, as noted previously, the first direction coincides with the Y-axis direction. Accordingly, the value of the arrangement angle of the thick-walled cylinder CP that is acquired by the acquisition unit 210 as a value indicating the first direction is 0 degrees.

The penetration angle of the through hole HE is an angle that the second direction in which the second central axial line A2 of the circular cylinder CS that forms the shape of the through hole HE extends forms with respect to the Z-axis. In the present embodiment, as noted previously, the second direction coincides with the Z-axis direction. Accordingly, the value of the penetration angle of the through hole HE that is acquired by the acquisition unit 210 as a value indicating the second direction is 0 degrees.

The option data includes an amount of cutting Q and a tolerance amount TA. By the tool CI cutting the ridge line RL at a predetermined machining width W at the first position C corresponding to the machining target point P, the burr BR is removed. By the ridge line RL being cut, a machining surface of the predetermined machining width W is formed between the cylindrical circumferential surface SS of the thick-walled cylinder CP and the circumferential wall surface SW of the through hole HE. More specifically, a distance between both ends of the machining surface in a machining widthwise direction is equal to the predetermined machining width W.

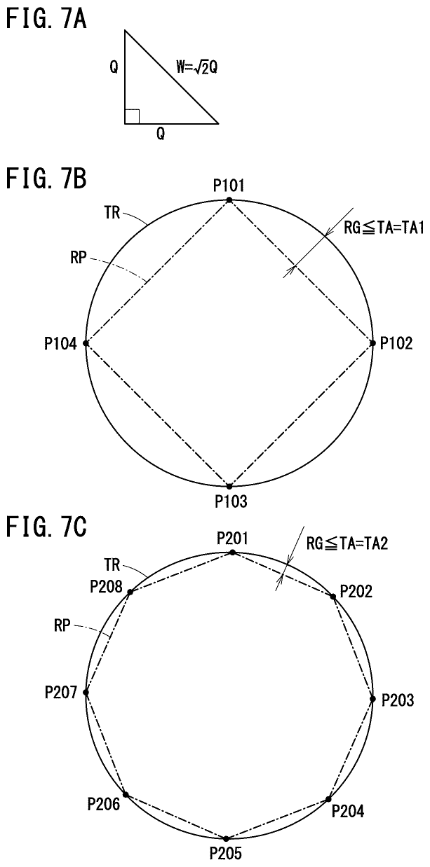

FIG. 7A is a diagram for the purpose of describing a relationship between the amount of cutting Q and the predetermined machining width W. As is clear from FIG. 7A, the predetermined machining width W is expressed by Equation (1) using the amount of cutting Q. The predetermined machining width W is specified by a user input in which the amount of cutting Q is used. The amount of cutting Q is a value that is 1/√2 times the predetermined machining width W. When the amount of cutting Q is specified by the user via the input/output device 130, the acquisition unit 210, by acquiring the amount of cutting Q, thereby acquires the predetermined machining width W.

$$W = \sqrt{2} \cdot Q \qquad ( 1 )$$

The tolerance amount TA indicates a value related to a machining path RP, when the tool CI cuts the ridge line RL while moving along the machining path RP corresponding to the ridge line RL. When the first position C of the tool CI corresponding to all (an infinite number of) the machining target points P on the ridge line RL is calculated, an ideal trajectory (ideal path) TR of the tool CI is determined. However, in actuality, the first position C of the tool CI corresponding to a finite number of machining target points P is calculated. Therefore, the machining path RP that is formed by linearly connecting the finite number of the machining target points P does not coincide with the ideal trajectory TR.

The tolerance amount TA is specified by a user as an upper limit value of an error in the machining path RP with respect to the ideal trajectory TR. When the tolerance amount TA is specified, a plurality of the machining target points P on the ridge line RL are determined based on the tolerance amount TA by the determination unit 220 of the computation device 110.

FIG. 7B and FIG. 7C are diagrams for the purpose of describing the tolerance amount TA. The plurality of machining target points P are determined, in a manner so that an error RG in the machining path RP with respect to the ideal trajectory TR of the tool CI lies within the tolerance amount TA. In the example shown in FIG. 7B, a value TA1 is specified by a user input as the tolerance amount TA. In this case, four machining target points P101, P102, P103, and P104 are determined, in a manner so that the error RG becomes less than or equal to the value TA1.

In the example shown in FIG. 7C, a value TA2 which is smaller than the value TA1 is specified by a user input as the tolerance amount TA. In this case, eight machining target points P201, P202, P203, P204, P205, P206, P207, and P208 are determined, in a manner so that the error RG becomes less than or equal to the value TA2. The number of machining target points P in FIG. 7C is greater than the number of machining target points P in FIG. 7B. The machining path RP in FIG. 7C is closer to the ideal trajectory TR than the machining path RP shown in FIG. 7B.

When the tolerance amount TA is set to a small value, since the upper limit of the error RG becomes smaller, the machining path RP becomes closer to the ideal trajectory TR. On the other hand, when the tolerance TA is set to a small value, since the number of machining target points P becomes more plentiful, the computational load imposed on the computation device 110 becomes higher. Accordingly, the user inputs the tolerance amount TA to the computation device 110 via the input/output device 130, while taking into consideration how close the machining path RP should be to the ideal trajectory TR, and the computational load. In the case that the tolerance TA has not been input by the user, a predetermined default setting value of the tolerance amount TA is used.

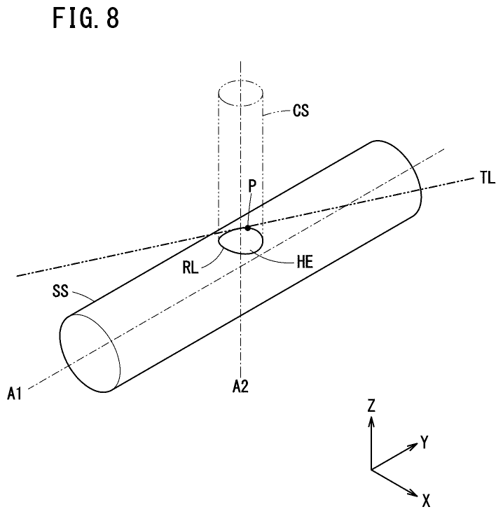

A tangent line to the ridge line RL of the through hole HE will hereinafter be referred to as a tangent line TL. FIG. 8 is a diagram for the purpose of describing the through hole HE that penetrates, in the shape of the circular cylinder CS, through the thick-walled cylinder CP, and the tangent line TL to the ridge line RL of the through hole HE. The cylindrical circumferential surface SS of the thick-walled cylinder CP is shown in FIG. 8. In the case that the burr BR generated on the inner circumferential surface SN of the thick-walled cylinder CP is removed, the inner circumferential surface SN corresponds to the cylindrical circumferential surface SS. In the case that the burr BR generated on the outer circumferential surface ST of the thick-walled cylinder CP is removed, the outer circumferential surface ST corresponds to the cylindrical circumferential surface SS. The central axial line of the cylindrical circumferential surface SS coincides with the first central axial line A1 of the thick-walled cylinder CP. More specifically, the direction in which the central axial line of the cylindrical circumferential surface SS extends is the first direction, which is the Y-axis direction.

The above-described imaginary circular cylinder CS that intersects with the cylindrical circumferential surface SS of the thick-walled cylinder CP is shown in FIG. 8. The circular cylinder CS is inserted through the through hole HE. The ridge line RL of the through hole HE is shown as an intersection line obtained by intersecting the cylindrical circumferential surface SS of the thick-walled cylinder CP, and the circular cylinder CS. As noted previously, the direction in which the second central axial line A2 of the circular cylinder CS extends is the second direction, which is the Z-axis direction. The second direction in which the second central axial line A2 extends is perpendicular to the first direction in which the first central axial line A1 extends.

The tangent line TL to the ridge line RL of the through hole HE, at the machining target point P on the ridge line RL that is cut by the tool CI is shown in FIG. 8. The tool CI has a spherical cutting surface. When a line connecting the center of the sphere and the machining target point P is perpendicular to the tangent line TL, excessive cutting does not occur when the ridge line RL is cut by the tool CI. In this case, the center position of the sphere that forms the cutting surface is defined as the first position C of the tool CI. More specifically, the first position C of the tool CI is on a vertical plane VP that is perpendicular to the tangent line TL of the ridge line RL and that includes the machining target point P.

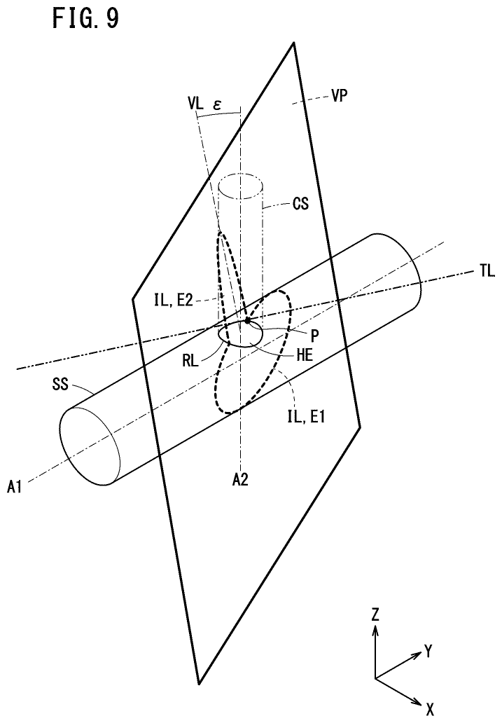

FIG. 9 is a diagram for the purpose of describing the vertical plane VP that is perpendicular to the tangent line TL of the ridge line RL of the through hole HE, and a first ellipse E1 and a second ellipse E2 that are formed on the vertical plane VP. The aforementioned vertical plane VP is determined based on the position of the machining target point P on the ridge line RL, and the machining target data acquired by the acquisition unit 210 of the computation device 110. The position of the machining target point P on the ridge line RL will hereinafter be referred to as a fourth position.

In FIG. 9, an angle ε that the second central axial line A2 of the imaginary circular cylinder CS forming the shape of the through hole HE makes with respect to the vertical plane VP is shown as an angle that the second central axial line A2 makes with respect to a straight line VL. The straight line VL is obtained by projecting the second central axial line A2 onto the vertical plane VP. A description will be given later concerning the calculation of the angle ε.

An intersection curve IL is obtained by the intersection of the vertical plane VP with the cylindrical circumferential surface SS and the circular cylinder CS. The intersection curve IL includes portions of contour lines of the first ellipse E1 and the second ellipse E2 that are formed on the vertical plane VP. The first ellipse E1 is formed as an intersection line between the vertical plane VP and the cylindrical circumferential surface SS. The second ellipse E2 is formed as an intersection line between the vertical plane VP and the circular cylinder CS. On the vertical plane VP, the fourth position of the machining target point P is on the contour line of the first ellipse E1, and further, is on a contour line of the second ellipse E2.

A solid portion between the outer circumferential surface ST and the inner circumferential surface SN of the thick-walled cylinder CP will hereinafter be referred to as a cylindrical shell of the thick-walled cylinder CP. A region on the outer side of the first ellipse E1 corresponds to a region on the outer side of the cylindrical circumferential surface SS. In the case that the cylindrical circumferential surface SS corresponds to the inner circumferential surface SN of the thick-walled cylinder CP, then at the fourth position of the machining target point P on the ridge line RL and in the vicinity thereof, the cylindrical shell of the thick-walled cylinder CP is included within the region on the outer side of the first ellipse E1. A region on the inner side of the first ellipse E1 corresponds to a region on the inner side of the cylindrical circumferential surface SS. In the case that the cylindrical circumferential surface SS corresponds to the outer circumferential surface ST of the thick-walled cylinder CP, then at the fourth position of the machining target point P on the ridge line RL and in the vicinity thereof, the cylindrical shell of the thick-walled cylinder CP is included within the region on the inner side of the first ellipse E1.

A region on the inner side of the second ellipse E2 corresponds to a region on the inner side of the circular cylinder CS. At the fourth position of the machining target point P on the ridge line RL and in the vicinity thereof, the through hole HE is included within the region on the inner side of the second ellipse E2. A segment from the machining target point P on the ridge line RL to a position at a predetermined distance along the contour line of the second ellipse E2 is formed by the circumferential wall surface SW that forms the through hole HE.

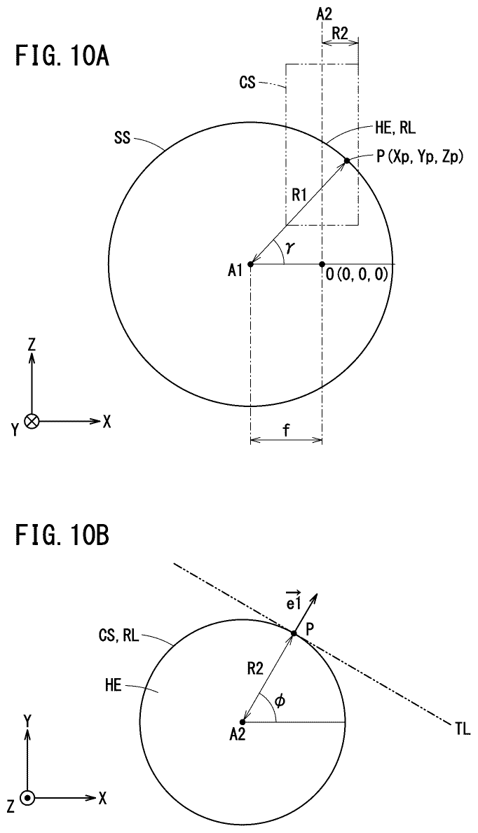

FIG. 10A is a diagram showing an angle γ formed by a perpendicular line from the machining target point P on the ridge line RL of the through hole HE to the first central axial line A1 of the thick-walled cylinder CP with respect to the X-axis. In FIG. 10A, a case is shown in which the cylindrical circumferential surface SS of the thick-walled cylinder CP shown in FIG. 3B, FIG. 8, and FIG. 9, and the imaginary circular cylinder CS that forms the shape of the through hole HE are viewed from the negative direction of the Y-axis.

In FIG. 10A, a point O (0, 0, 0) on the second central axial line A2 is shown whose distance from the first central axial line A1 is equal to the eccentric distance f. In the present embodiment, position data included in the machining target data is represented by a three-dimensional coordinate value in the XYZ space with the point O serving as an origin point. In FIG. 10A, a three-dimensional coordinate value (Xp, Yp, Zp) in the XYZ space that indicates the fourth position of the machining target point P is shown. The fourth position of the machining target point P is on the ridge line RL that is determined based on the machining target data.

From within the cylindrical circumferential surface SS shown in FIG. 10A, a region included inside the circular cylinder CS corresponds to the through hole HE. Since the machining target point P is on the ridge line RL of the through hole HE, the machining target point P is positioned within the aforementioned region. The length of a perpendicular line from the machining target point P to the first central axial line A1 is equal to the length of the first radius R1 of the cylindrical circumferential surface SS. The fourth position of the machining target point P is expressed by a parameter that is the angle γ that the perpendicular line forms with respect to the X-axis.

When the eccentric distance f is taken into consideration, the X component Xp of the aforementioned three-dimensional coordinate value representing the fourth position of the machining target point P is expressed by Equation (2) using the machining target data. The Z component Zp of the three-dimensional coordinate value indicating the fourth position of the machining target point P is expressed by Equation (3) using the machining target data. Since the machining target point P is positioned on the cylindrical circumferential surface SS, Equation (4) is obtained based on the Equation (2) and the Equation (3).

$$Xp = R 1 \cdot cos γ - f \qquad ( 2 )$$

$$Zp = R 1 \cdot sin γ \qquad ( 3 )$$

$${( Xp + f )}^{2} + {Zp}^{2} = R {1}^{2} \qquad ( 4 )$$

FIG. 10B is a diagram showing an angle ϕ formed with respect to the X-axis by a perpendicular line from the machining target point P on the ridge line RL of the through hole HE to the second central axial line A2 of the circular cylinder CS that forms the shape of the through hole HE, and a first basis vector e1.

In FIG. 10B, the imaginary circular cylinder CS shown in FIG. 3B, FIG. 8, and FIG. 9, as viewed from the positive direction of the Z-axis is shown. Since the machining target point P is on the ridge line RL of the through hole HE, the aforementioned angle ϕ is a value that is greater than 0 degrees, and further, is a value that is less than or equal to 360 degrees (0°<ϕ≤360°). However, the upper limit value of the angle ϕ may be less than 360°.

The length of a perpendicular line from the machining target point P to the second central axial line A2 is equal to the length of the second radius R2 of the circular cylinder CS. The fourth position of the machining target point P is expressed by a parameter that is the angle ϕ that the perpendicular line forms with respect to the X-axis. The X component Xp of the aforementioned three-dimensional coordinate value representing the fourth position of the machining target point P is expressed by Equation (5) using the machining target data. Equation (6) is obtained based on the Equation (2) and the Equation (5). The Y component Yp of the three-dimensional coordinate value indicating the fourth position of the machining target point P is expressed by Equation (7) using the processing target data. More specifically, the three-dimensional coordinate value (Xp, Yp, Zp) representing the fourth position of the machining target point P is obtained using the machining target data.

$$Xp = R 2 \cdot cos ϕ \qquad ( 5 )$$

$$R 1 \cdot cos γ - f = R 2 \cdot cos ϕ \qquad ( 6 )$$

$$Yp = R 2 \cdot sin ϕ \qquad ( 7 )$$

In FIG. 10B, the tangent line TL to the ridge line RL at the machining target point P is shown. A vector that is perpendicular to this tangent line TL, and further, that passes through the machining target point P is included in the aforementioned vertical plane VP. A vector that has the machining target point P as its starting point, that is perpendicular to the second central axial line A2, and further, that forms the angle ϕ with the X-axis, is defined as the first basis vector e1 of the vertical plane VP. In the case that the magnitude of the first basis vector e1 is assumed to be 1, the three-dimensional coordinate value of the first basis vector e1 in the XYZ space is expressed by Equation (8) using the angle ϕ as a parameter.

$$\vec{e 1} = ( \begin{matrix}cos ϕ \\ sin ϕ \\ 0\end{matrix} ) \qquad ( 8 )$$

The three dimensional coordinate value of the second basis vector e2, with the machining target point P serving as the starting point P and which is perpendicular, on the vertical plane VP, to the first basis vector e1, is shown by Equation (9) as a vector having a magnitude of 1, based on the Equation (6) and the Equation (8). The first computation unit 230 of the computation device 110 calculates, in accordance with the Equation (8) and the Equation (9) in which the machining target data is used, the first basis vector e1 and the second basis vector e2 with respect to each of the plurality of machining target points P.

$$\vec{e 2} = ( \begin{matrix}\frac{( R 2 \cdot cos ϕ + f ) \cdot {sin}^{2} ϕ}{\sqrt{R {1}^{2} - {( R 2 \cdot cos ϕ + f )}^{2} \cdot {cos}^{2} ϕ}} \\ \frac{- ( R 2 \cdot cos ϕ + f ) \cdot sin ϕ cos ϕ}{\sqrt{R {1}^{2} - {( R 2 \cdot cos ϕ + f )}^{2} \cdot {cos}^{2} ϕ}} \\ \frac{\sqrt{R {1}^{2} - {( R 2 \cdot cos ϕ + f )}^{2}}}{\sqrt{R {1}^{2} - {( R 2 \cdot cos ϕ + f )}^{2} \cdot {cos}^{2} ϕ}}\end{matrix} ) \qquad ( 9 )$$

The second basis vector e2 of the vertical plane VP is parallel to the straight line VL on the vertical plane VP shown in FIG. 9. The second central axial line A2 of the circular cylinder CS is parallel to the Z-axis. Accordingly, the angle ε that the second central axial line A2 forms with respect to the vertical plane VP satisfies Equation (10). More specifically, the angle ε is calculated by the Equation (9) and the Equation (10) based on the machining target data.

$$cos ε = \vec{e 2} \cdot ( \begin{matrix}0 \\ 0 \\ 1\end{matrix} ) \qquad ( 10 )$$

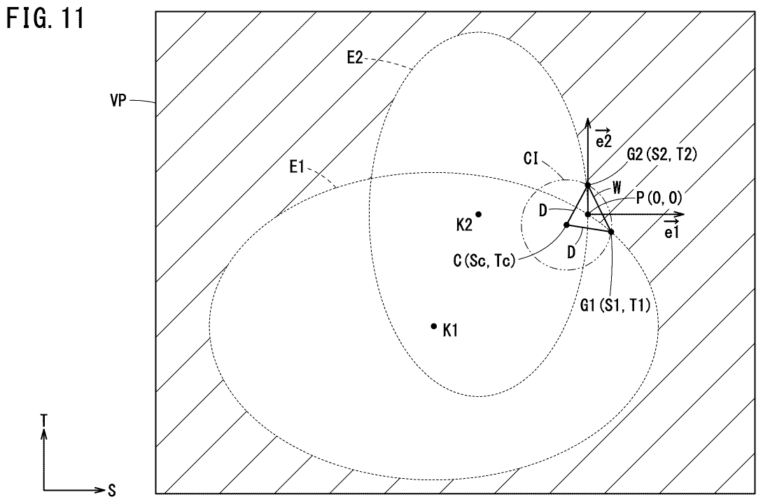

FIG. 11 is a diagram of the first position C of the tool CI for removing the burr BR that is generated on the inner circumferential surface SN of the thick-walled cylinder CP, as well as the first basis vector e1 and the second basis vector e2. A center K1 of the first ellipse and a center K2 of the second ellipse are shown in FIG. 11. A direction in which the major axis of the second ellipse E2 passing through the center K2 extends is a T-axis direction, and a direction perpendicular to the T-axis (the direction in which the minor axis of the second ellipse E2 passing through the center K2 extends) is an S-axis direction. The vertical plane VP is a plane formed by the S-axis (a horizontal axis) and the T-axis (a vertical axis) which are orthogonal to each other. The origin point of the vertical plane VP is the machining target point P (0, 0) on the ridge line RL.

The first basis vector e1 is parallel to the S-axis, and the second basis vector e2 is parallel to the T-axis. The positive direction of the S-axis is a direction from the origin point toward the outer side of the second ellipse E2. The angle that the S-axis makes with respect to the X-axis is equal to the aforementioned angle ϕ. The positive direction of the T-axis is a direction from the origin point toward the outer side of the first ellipse E1.

The second ellipse E2 can be formulated by a two-dimensional coordinate value of the center K2 on the vertical plane VP and by a parametric representation based on an eccentric anomaly using the major axis and the minor axis. The angle that the T-axis makes with respect the Z-axis is equal to the aforementioned angle ε. Accordingly, the second ellipse E2 on the vertical plane VP defined by the S-axis (the variable S) and the T-axis (the variable T) is expressed by Equation (11).

$$\frac{{( S + R 2 )}^{2}}{R {2}^{2}} + \frac{{T}^{2}}{{( \frac{R 2}{sin ε} )}^{2}} = 1 \qquad ( 11 )$$

At the machining target point P on the ridge line RL, the cylindrical shell of the thick-walled cylinder CP having the through hole HE is included within a region that is on the outer side of the first ellipse E1, and further, is on the outer side of the second ellipse E2. The contour line of the first ellipse E1 extending from the machining target point P corresponds to the inner circumferential surface SN of the thick-walled cylinder CP. The contour line of the second ellipse E2 extending from the machining target point P corresponds to the circumferential wall surface SW that forms the through hole HE.

When the tool CI cuts the ridge line RL at the first position C corresponding to the machining target point P on the ridge line RL, the machining surface of the predetermined machining width W is formed between the inner circumferential surface SN of the thick-walled cylinder CP and the circumferential wall surface SW of the through hole HE. A first end point G1 and a second end point G2 on the vertical plane VP corresponding to both ends in the machining widthwise direction of the machining surface are shown in FIG. 11. The first end point G1 is positioned on the inner circumferential surface SN (the cylindrical circumferential surface SS) of the thick-walled cylinder CP. The second end point G2 is positioned on the circumferential wall surface SW of the through hole HE (a region of a portion within the circular shaped circumferential surface of the imaginary circular cylinder CS). The straight line distance between the first end point G1 and the second end point G2 is equal to the predetermined machining width W.

The three-dimensional coordinate value (X1, Y1, Z1) of the first end point G1 in the XYZ space is expressed by Equation (12) using the three-dimensional coordinate value (Xp, Yp, Zp) representing the fourth position of the machining target point P, the two-dimensional coordinate value (S1, T1) of the first end point G1 on the vertical plane VP, and the first basis vector e1 and the second basis vector e2.

$$( \begin{matrix}X 1 \\ Y 1 \\ Z 1\end{matrix} ) = ( \begin{matrix}Xp \\ Yp \\ Zp\end{matrix} ) + S 1 \cdot \vec{e 1} + T 1 \cdot \vec{e 2} \qquad ( 12 )$$

The first end point G1 is positioned on the contour line of the first ellipse E1. From the fact that the contour line of the first ellipse E1 is the intersection line between the inner circumferential surface SN (the cylindrical circumferential surface SS) of the thick-walled cylinder CP and the vertical plane VP, the first end point G1 is positioned on the cylindrical circumferential surface SS in the same manner as the machining target point P. Accordingly, the X component X1 and the Z component Z1 from within the three-dimensional coordinate value (X1, Y1, Z1) of the first end point G1 in the XYZ space satisfies Equation (13), in the same manner as the machining target point P that satisfies the Equation (4).

$${( X 1 + f )}^{2} + Z {1}^{2} = R {1}^{2} \qquad ( 13 )$$

The second endpoint G2 is located on the contour line of the second ellipse E2. From the fact that the two-dimensional coordinate value (S2, T2) of the second end point G2 satisfies the Equation (11) that represents the second ellipse E2, Equation (14) is satisfied.

$$\frac{{( S 2 + R 2 )}^{2}}{R {2}^{2}} + \frac{T {2}^{2}}{{( \frac{R 2}{sin ε} )}^{2}} = 1 \qquad ( 14 )$$

A cross section of the sphere forming the cutting surface of the tool CI is represented in FIG. 11 as a circle that passes through the first end point G1 and the second end point G2 corresponding to both ends in the machining widthwise direction of the aforementioned machining surface on the vertical plane VP. A length from the first position C of the tool CI, which is indicated as the center of the circle, to the first end point G1, and a length from the first position C of the tool CI to the second end point G2 are both equal to a third radius D of the tool CI.

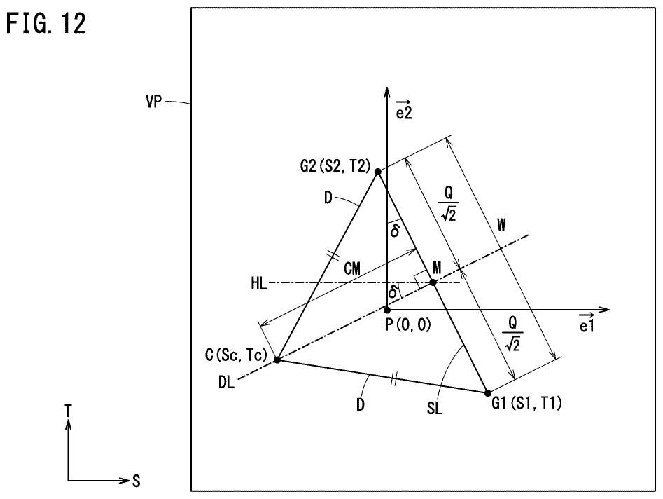

FIG. 12 is a diagram for the purpose of describing how the first position C of the tool CI corresponding to the machining target point P on the ridge line RL of the through hole HE is calculated based on the predetermined machining width W. As noted previously, the first end point G1 and the second end point G2 correspond to both ends in the machining widthwise direction of the machining surface formed by the tool CI cutting the ridge line RL at the first position C corresponding to the machining target point P.

As noted previously, the length from the first position C of the tool CI to the first end point G1, and the length from the first position C of the tool CI to the second end point G2 are both equal to the third radius D of the tool CI. Accordingly, the straight line DL that connects a midpoint M of a line segment SL that connects the first end point G1 and the second end point G2 and the first position C of the tool CI perpendicularly intersects with the line segment SL at the midpoint M. The position of the midpoint M on the vertical plane VP is expressed as a two-dimensional coordinate value ((S1+S2)/2, (T1+T2)/2).

As noted previously, the distance between the first end point G1 (S1, T1) and the second end point G2 (S2, T2) is equal to the predetermined machining width W. According to the Equation (1), the predetermined machining width W can be expressed by replacing it with the amount of cutting Q. Accordingly, Equation (15) is obtained.

$${( S 1 - S 2 )}^{2} + {( T 1 - T 2 )}^{2} = 2 {Q}^{2} \qquad ( 15 )$$

The length of the line segment SL is equal to the distance between the first end point G1 and the second end point G2, and therefore, is equal to the predetermined machining width W. The length from the midpoint M of the line segment SL to the first end point G1 becomes ½ of the predetermined machining width W. As noted previously, the length from the first position C of the tool CI to the first end point G1 is equal to the third radius D of the tool CI. Accordingly, a length CM from the first position C of the tool CI to the midpoint M of the line segment SL is obtained by Equation (16).

$$C M = \sqrt{{D}^{2} - \frac{{Q}^{2}}{2}} \qquad ( 16 )$$

The direction in which a line segment SL connecting the first end point G1 (S1, T1) and the second end point G2 (S2, T2) extends is the machining widthwise direction of the machining surface that is formed by cutting. In FIG. 12, an angle δ that the line segment SL forms with respect the second basis vector e2 is calculated based on the machining target data and the amount of cutting Q. The acquisition unit 210 of the computation device 110 acquires the angle δ that is calculated.

The angle δ that the line segment SL forms with respect to the second basis vector e2 may be constant, or alternatively, may be different for each of the machining target points P. The angle δ, for example, may be an angle that is equal to a complementary angle of an angle obtained by bisecting an angle between the respective tangent lines that are tangential to the first ellipse E1 and the second ellipse E2 at the machining target points P. In this case, the occurrence of burrs caused by the tool CI cutting the ridge line RL can be comparatively suppressed.

With reference to FIG. 12, Equation (17) using the angle δ is obtained. Moreover, the angle δ is a value that is greater than 0 degrees, and further, is a value that is less than or equal to 90 degrees (0°<δ≤90°).

$$\frac{T 1 - T 2}{S 1 - S 2} = - \frac{1}{tan δ} \qquad ( 17 )$$

The angle that the aforementioned straight line DL makes with respect to an auxiliary line HL that passes through the midpoint M of the line segment SL, and further, is parallel to the first basis vector e1 is equal to the angle δ. The length CM from the first position C of the tool CI to the midpoint M of the line segment SL is obtained by the Equation (16). Accordingly, the two-dimensional coordinate value (Sc, Tc) representing the first position C of the tool CI on the vertical plane VP is shown by Equation (18) and Equation (19), using the aforementioned two-dimensional coordinate value of the midpoint M of the line segment SL.

$$S c = \frac{S 1 + S 2}{2} - \sqrt{{D}^{2} - \frac{1}{2} {Q}^{2}} \cdot cos δ \qquad ( 18 )$$

$$Tc = \frac{T 1 + T 2}{2} - \sqrt{{D}^{2} - \frac{1}{2} {Q}^{2}} \cdot sin δ \qquad ( 19 )$$

The second computation unit 240 of the computation device 110 calculates the two-dimensional coordinate value (Sc, Tc) of the first position C of the tool CI on the vertical plane VP, using Equation (12) to Equation (15) and Equation (17) to Equation (19). Based on the calculation result, the first position C of the tool CI in a coordinate space defined by the X-axis, the Y-axis, and the Z-axis can be calculated.

The second computation unit 240 calculates, for each of the plurality of machining target points P, the three-dimensional coordinate value (Xc, Yc, Zc) of the first position C of the tool CI using Equation (20).

$$( \begin{matrix}X c \\ Y c \\ Z c\end{matrix} ) = ( \begin{matrix}Xp \\ Yp \\ Zp\end{matrix} ) + Sc \cdot \vec{e 1} + Tc \cdot \vec{e 2} \qquad ( 20 )$$

The Equation (20) includes the three-dimensional coordinate value (Xp, Yp, Zp) of the machining target point P. The three-dimensional coordinate value (Xp, Yp, Zp) of the machining target point P is obtained using the machining target data as described above.

The first basis vector e1 and the second basis vector e2 on the vertical plane VP are included in the Equation (20). The first basis vector e1 and the second basis vector e2 on the vertical plane VP are calculated by the first computation unit 230 based on Equation (8) and Equation (9).

The two-dimensional coordinate value (Sc, Tc) of the first position C of the tool CI on the vertical plane VP is included in the Equation (20). The two-dimensional coordinate value (Sc, Tc) of the first position C on the vertical plane VP is calculated by the second computation unit 240 based on Equation (12) to Equation (15) and Equation (17) to Equation (19).

More specifically, the second computation unit 240 calculates the three-dimensional coordinate value (Xc, Yc, Zc) of the first position C of the tool CI, based on the aforementioned angle δ, the machining target data acquired by the acquisition unit 210, the second ellipse E2 formulated using the aforementioned angle ε based on the machining target data, the predetermined machining width W, the third radius D of the tool CI, the first basis vector e1 and the second basis vector e2 on the vertical plane VP, and the three-dimensional coordinate value (Xp, Yp, Zp) representing the fourth position of the machining target point P. Each of the machining target points P becomes closest in proximity to the first position C of the tool CI on the ridge line RL.

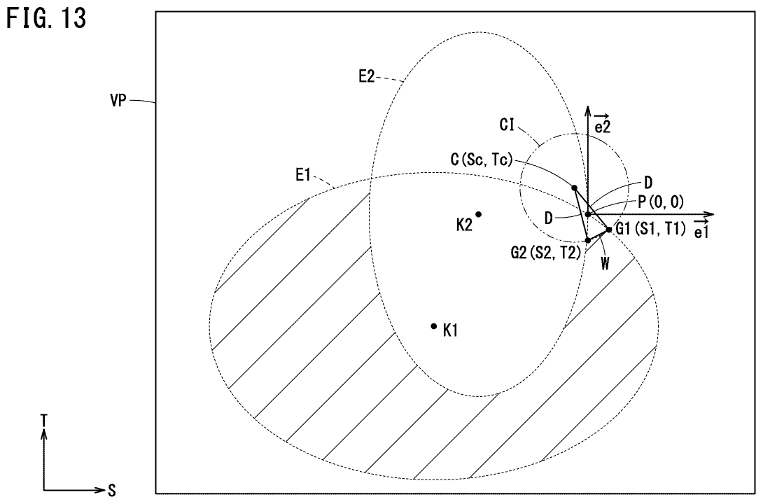

FIG. 13 is a diagram showing the first position of the tool CI for removing the burr BR that is generated on the outer circumferential surface ST of the thick-walled cylinder CP, as well as the first basis vector e1 and the second basis vector e2. In FIG. 13, in the same manner as in FIG. 11, the origin point of the vertical plane VP is the machining target point P (0, 0) on the ridge line RL. The first basis vector e1 and the second basis vector e2 of the vertical plane VP are parallel, respectively, to the S-axis and the T-axis. The first ellipse E1 and the second ellipse E2 can be formulated on the vertical plane VP. Among these ellipses, the second ellipse E2 in particular is expressed by the aforementioned Equation (11).

At the machining target point P on the ridge line RL, the cylindrical shell of the thick-walled cylinder CP is included within a region that is on the inner side of the first ellipse E1, and further, is on the outer side of the second ellipse E2. The contour line of the first ellipse E1 extending from the machining target point P corresponds to the outer circumferential surface ST of the thick-walled cylinder CP. The contour line of the second ellipse E2 extending from the machining target point P corresponds to the circumferential wall surface SW that forms the through hole HE.

When the tool CI cuts the ridge line RL at the first position C corresponding to the machining target point P on the ridge line RL, the machining surface of the predetermined machining width W is formed between the outer circumferential surface ST of the thick-walled cylinder CP and the circumferential wall surface SW of the through hole HE. The first end point G1 and the second end point G2 corresponding to both ends in the machining widthwise direction of the machining surface are shown in FIG. 13. The first end point G1 is positioned on the outer circumferential surface ST (the cylindrical circumferential surface SS) of the thick-walled cylinder CP. The second end point G2 is positioned on the circumferential wall surface SW of the through hole HE (a region of a portion within the circular shaped circumferential surface of the imaginary circular cylinder CS). The straight line distance between the first end point G1 and the second end point G2 is equal to the predetermined machining width W.

The three-dimensional coordinate value (X1, Y1, Z1) of the first end point G1 in the XYZ space is expressed by the aforementioned Equation (12). Since the first end point G1 is positioned on the contour line of the first ellipse E1, the first end point G1 is also positioned on the cylindrical circumferential surface SS. Accordingly, the X component X1 and the Z component Z1 of the three-dimensional coordinate value (X1, Y1, Z1) of the first endpoint G1 in the XYZ space satisfy the Equation (13).

The second end point G2 is positioned on the contour line of the second ellipse E2. From the fact that the two-dimensional coordinate value (S2, T2) of the second end point G2 satisfies the Equation (11) that represents the second ellipse E2, the aforementioned Equation (14) is satisfied. The two-dimensional coordinate value (S1, T1) of the first endpoint G1 and the two-dimensional coordinate value (S2, T2) of the second endpoint G2 satisfy the aforementioned Equation (15).

A cross section of the sphere forming the cutting surface of the tool CI is represented in FIG. 13 as a circle that passes through the first end point G1 and the second end point G2 corresponding to both ends of the aforementioned machining surface on the vertical plane VP. A length from the first position C of the tool CI, which is indicated as the center of the circle, to the first end point G1, and a length from the first position C of the tool CI to the second end point G2 are both equal to the third radius D of the tool CI.

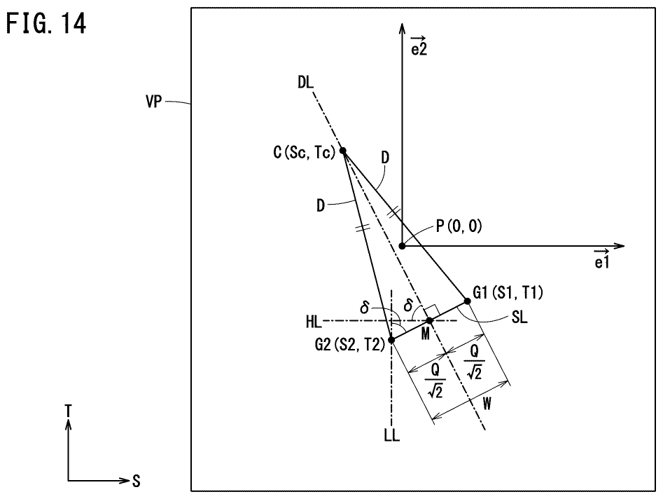

FIG. 14 is a diagram for the purpose of describing how the first position C of the tool CI corresponding to the machining target point P on the ridge line RL of the through hole HE is calculated based on the predetermined machining width W. As noted previously, the first end point G1 and the second end point G2 correspond to both ends in the machining widthwise direction of the machining surface formed by the tool CI cutting the ridge line RL at the first position C corresponding to the machining target point P.

As noted previously, the length from the first position C of the tool CI to the first end point G1, and the length from the first position C of the tool CI to the second end point G2 are both equal to the third radius D of the tool CI. Accordingly, the straight line DL that connects the midpoint M of the line segment SL that connects the first end point G1 and the second end point G2 and the first position C of the tool CI perpendicularly intersects with the line segment SL at the midpoint M. The position of the midpoint M on the vertical plane VP is expressed as a two-dimensional coordinate value ((S1+S2)/2, (T1+T2)/2). The length CM from the first position C of the tool CI to the midpoint M of the line segment SL is obtained by the aforementioned Equation (16).

The direction in which the line segment SL connecting the first end point G1 (S1, T1) and the second end point G2 (S2, T2) extends is the machining widthwise direction of the machining surface that is formed by cutting. As noted previously above, based on the machining target data and the amount of cutting Q, the acquisition unit 210 of the computation device 110 acquires the angle δ that the line segment SL makes with respect to the second basis vector e2.

In FIG. 14, the angle δ is indicated using an auxiliary line LL that passes through the second end point G2, and further, is parallel to the second basis vector e2. With reference to FIG. 14, Equation (21) in which the angle δ is used is obtained. Moreover, the angle δ is a value that is greater than 0 degrees, and further, is a value that is less than or equal to 90 degrees (0°<δ≤90°).

$$\frac{T 1 - T 2}{S 1 - S 2} = \frac{1}{tan δ} \qquad ( 21 )$$

The angle that the aforementioned straight line DL makes with respect to an auxiliary line HL that passes through the midpoint M of the line segment SL, and further, is parallel to the first basis vector e1 is equal to the angle δ. The length CM from the first position C of the tool CI to the midpoint M of the line segment SL is obtained by the Equation (16).

Accordingly, the two-dimensional coordinate value (Sc, Tc) representing the first position C of the tool CI on the vertical plane VP is shown by Equation (18) and Equation (22), using the aforementioned two-dimensional coordinate value of the midpoint M of the line segment SL.

$$T c = \frac{T 1 + T 2}{2} + \sqrt{{D}^{2} - \frac{1}{2} {Q}^{2}} \cdot sin δ \qquad ( 22 )$$

The second computation unit 240 of the computation device 110 calculates the two-dimensional coordinate value (Sc, Tc) of the first position C of the tool CI on the vertical plane VP, using Equation (12) to Equation (15), Equation (18), Equation (21), and Equation (22). Based on the calculation result, the first position C of the tool CI in a coordinate space defined by the X-axis, the Y-axis, and the Z-axis can be calculated.

The second computation unit 240 calculates, for each of the plurality of machining target points P, the three-dimensional coordinate value (Xc, Yc, Zc) of the first position C of the tool CI using Equation (20). More specifically, the second computation unit 240 calculates the three-dimensional coordinate value (Xc, Yc, Zc) of the first position C of the tool CI, based on the aforementioned angle δ, the machining target data acquired by the acquisition unit 210, the second ellipse E2 formulated using the aforementioned angle ε based on the machining target data, the predetermined machining width W, the third radius D of the tool CI, the first basis vector e1 and the second basis vector e2 on the vertical plane VP, and the three-dimensional coordinate value (Xp, Yp, Zp) representing the fourth position of the machining target point P. Each of the machining target points P becomes closest in proximity to the first position C of the tool CI on the ridge line RL.

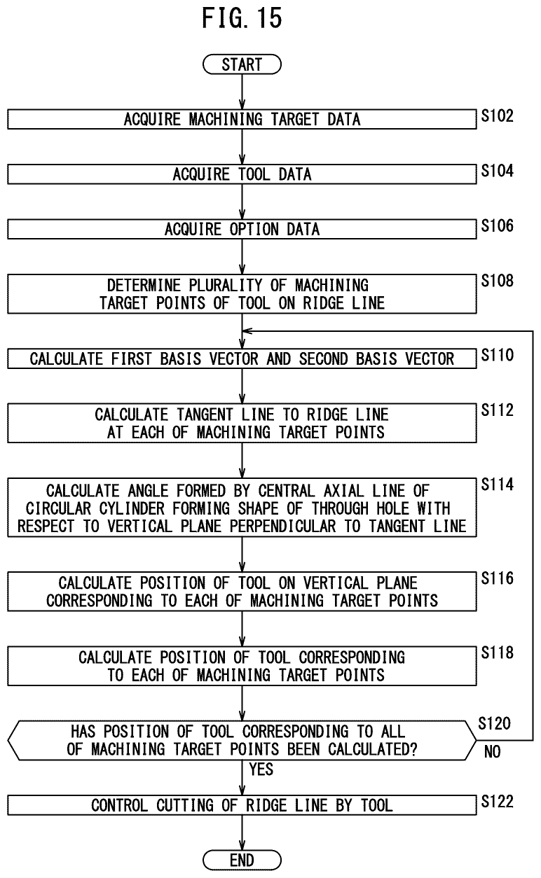

FIG. 15 is a flowchart showing a processing procedure executed by the control device 30 of the machine tool 10. The present processing procedure is performed, for example, by the computation device 110 of the control device 30 executing the computation program. When this processing procedure is initiated, in step S102, the acquisition unit 210 of the computation device 110 acquires the machining target data from the user, or alternatively, from the storage device 120.

The machining target data includes the second position of the thick-walled cylinder CP, the third position of the through hole HE, the first radius R1 of the cylindrical circumferential surface SS of the thick-walled cylinder CP, the second radius R2 of the imaginary circular cylinder CS that forms the shape of the through hole HE, the arrangement angle of the thick-walled cylinder CP, the penetration angle of the through hole HE, and the eccentric distance f. The arrangement angle of the thick-walled cylinder CP corresponds to the first direction in which the first central axial line A1 of the thick-walled cylinder CP extends. The value of the penetration angle of the through hole HE is 0 degrees.

In step S104, the acquisition unit 210 acquires the tool data from the storage device 120 based on the number of the tool CI designated by the user. As the tool data, the third radius D of the tool CI is associated with the number of the tool CI.

In step S106, the acquisition unit 210 acquires the option data. The option data includes the amount of cutting Q and the tolerance amount TA. When the amount of cutting Q is specified, the predetermined machining width W is determined. When the tolerance amount TA is specified, then in step S108, the determination unit 220 of the computation device 110 determines a plurality of the machining target points P on the ridge line RL. The three-dimensional coordinate value (Xp, Yp, Zp) representing the fourth position of each of the machining target points P is determined using the machining target data and the tolerance amount TA.

In step S110, the first computation unit 230 of the computation device 110 calculates the first basis vector e1 and the second basis vector e2 based on the machining target data.

In step S112, the second computation unit 240 of the computation device 110 calculates the tangent line TL to the ridge line RL at each of the machining target points P. In step S114, the second computation unit 240 calculates the angle ε that the second central axial line A2 of the imaginary circular cylinder CS forms with respect to the vertical plane VP that is perpendicular to the tangent line TL.

In step S116, the second computation unit 240 calculates the two-dimensional coordinate value (Sc, Tc) of the first position C of the tool CI on the vertical plane VP, which corresponds to each of the machining target points P. The two-dimensional coordinate value (Sc, Tc) of the first position C of the tool CI is calculated based on the machining target data, the aforementioned angle δ, the aforementioned angle ε, the three-dimensional coordinate value (Xp, Yp, Zp) representing the fourth position of the machining target point P, the predetermined machining width W, the third radius D of the tool CI, the first basis vector e1, and the second basis vector e2.

In step S118, the second computation unit 240 calculates the three-dimensional coordinate value (Xc, Yc, Zc) of the first position C of the tool CI corresponding to each of the machining target points P. The three-dimensional coordinate value (Xc, Yc, Zc) of the first position C of the tool CI is calculated based on the two-dimensional coordinate value (Sc, Tc) of the first position C of the tool CI on the vertical plane VP, the three-dimensional coordinate value (Xp, Yp, Zp) representing the fourth position of the machining target point P, the first basis vector e1 and the second basis vector e2 on the vertical plane VP.

In step S120, the second computation unit 240 determines whether or not the first positions C of the tool CI corresponding to all of the plurality of machining target points P determined in step S108 have been calculated. If the result becomes NO in step S120, the process returns to step S110. If the result becomes YES in step S120, the process proceeds to step S122. In step S122, the machining control unit 250 of the computation device 110 causes the tool CI to cut the ridge line RL at each of the respective machining target points P. When the process of step S122 is completed, the present processing procedure comes to an end.

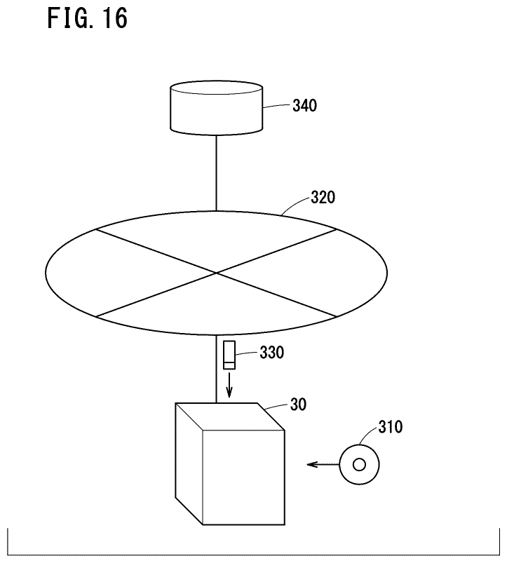

FIG. 16 is a diagram illustrating the computer program product of the computation program for causing the computation device 110 of the control device 30 to execute the processing procedure shown in FIG. 15. The aforementioned computation program is recorded in a recording medium (storage medium) 310 such as a CD-ROM or a USB memory or the like, and is supplied to the control device 30.

The computation program may be recorded in a data signal 330 that flows through a communication network 320 such as the Internet or the like, and may be supplied to the control device 30 by a server 340. The server 340 enables the computation program that is stored in a non-illustrated storage device to be carried as the data signal 330 in a carrier wave. The server 340 provides the computation program by transmitting the data signal 330 to the control device 30 via the communication network 320. In this manner, the computation program is provided in the form of a computer-readable computer program product such as the recording medium 310, or alternatively, the data signal 330 or the like.

### Exemplary Modifications

The above-described embodiment may be modified as indicated below.

### Exemplary Modification 1

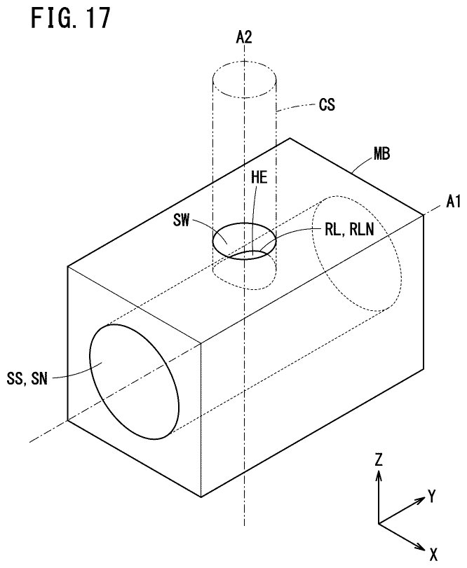

In the above-described embodiment, although the workpiece is the thick-walled cylinder CP, the workpiece is not necessarily limited to being the thick-walled cylinder CP. The workpiece may include an outer peripheral surface in the shape of a rectangular parallelepiped, and a cylindrically shaped hollow portion. As a workpiece provided with such a shape, there may be used, for example, a manifold block. FIG. 17 is a diagram illustrating a manifold block MB that is used as the workpiece. In FIG. 17, the manifold block MB is disposed on the XY plane.

Due to the hollow portion of the manifold block MB being of a cylindrical shape, the cylindrical circumferential surface SS is formed by the inner circumferential surface SN of the manifold block MB. The central axial line that passes through the center of the cylindrical circumferential surface SS is a first central axial line A1 of the manifold block MB. In the present exemplary modification, the first direction in which the first central axial line A1 of the manifold block MB extends is the Y-axis direction.

The through hole HE, which penetrates, in the shape of the circular cylinder CS, through the manifold block MB from the outer circumferential surface to the inner circumferential surface SN of the manifold block MB, is defined by the circumferential wall surface SW. The second direction in which the second central axial line A2 of the circular cylinder CS that forms the through hole HE extends is the Z-axis direction. In the present exemplary modification, the tool CI removes the burr BR that is formed on the inner circumferential surface SN of the manifold block MB.

The ridge line RL that forms the edge of the through hole HE is the ridge line RLN. The ridge line RLN is formed by the circumferential wall surface SW of the through hole HE, and the inner circumferential surface SN of the manifold block MB. In the same manner as the case in which the workpiece is the thick-walled cylinder CP, the second computation unit 240 calculates the first position C of the tool CI that cuts the ridge line RLN of the manifold block MB at the predetermined machining width W.

### Exemplary Modification 2

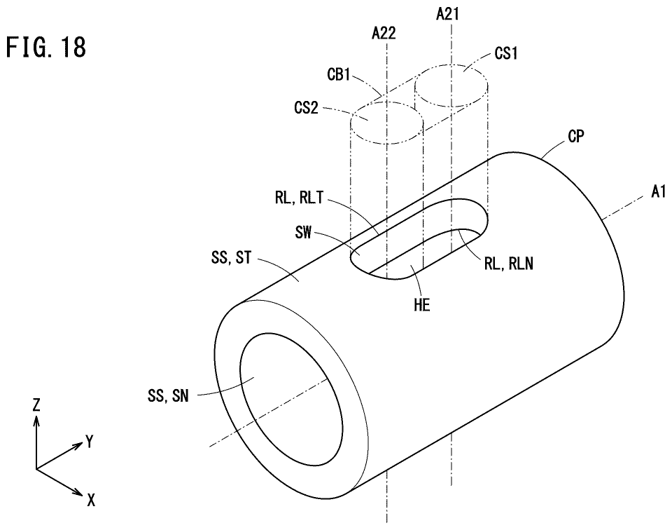

In the above-described embodiment, in the case that the through hole HE that penetrates through the thick-walled cylinder CP is viewed from directly above the through hole HE, the through hole HE is of a circular shape. However, instead of such a through hole HE having a circular shape, a through hole HE having an elongated hole shape may be provided in the thick-walled cylinder CP. FIG. 18 is a diagram for the purpose of describing the thick-walled cylinder CP, and the through hole HE having such an elongated hole shape that penetrates through the thick-walled cylinder CP. In FIG. 18, instead of the circular through hole HE shown in FIG. 3A, the through hole HE having such an elongated hole shape is formed in the thick-walled cylinder CP.

The ridge line RL of the through hole HE includes two circular arc-shaped segments that form a circular-arcuate shape in the case of being viewed from directly above the through hole HE, and two straight line-shaped segments that are parallel to the first direction (the direction of the Y-axis). As noted previously, the first direction is the direction in which the first central axial line A1 of the thick-walled cylinder CP extends. The two circular arc-shaped segments constitute both corners (both ends), within the ridge line RL, of the through hole HE which is of the elongated hole shape. These two circular arc-shaped segments are connected, via the aforementioned two straight line-shaped segments, in a manner so as to form the ridge line RL.

The through hole HE having the elongated hole shape penetrates, in the shape of an imaginary columnar body CB1 shown in FIG. 18, through the thick-walled cylinder CP from the outer circumferential surface ST to the inner circumferential surface SN of the thick-walled cylinder CP. The columnar body CB1 includes two imaginary parallel circular cylinders CS1 and CS2 respectively at both corners (both ends) of the columnar body CB1. The second direction in which each of the central axial line A21 of the circular cylinder CS1 and the central axial line A22 of the circular cylinder CS2 extends is the direction of the Z-axis. Accordingly, the central axial lines A21 and A22 are parallel to each other. In the case that the through hole HE is viewed from directly above the through hole HE along the Z-axis, the through hole HE is of an elongated hole shape corresponding to the columnar body CB1. The through hole HE is defined by the circumferential wall surface SW.

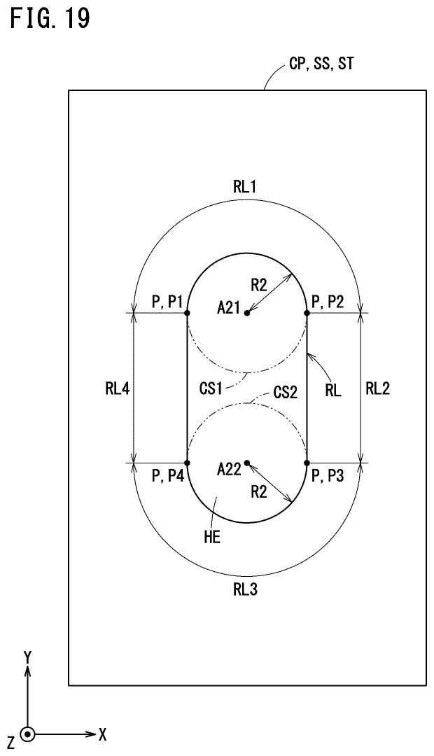

FIG. 19 is a diagram schematically showing the through hole HE having the elongated hole shape. In FIG. 19, a case is shown in which the thick-walled cylinder CP having the through hole HE of the elongated hole shape is viewed from the positive direction of the Z-axis on the outer side of the thick-walled cylinder CP. In FIG. 19, circular shaped bottom surfaces of the two imaginary circular cylinders CS1 and CS2 are shown in the through-hole HE having the elongated hole shape. The radius of the circular cylinder CS1 is equal to the radius of the circular cylinder CS2. The radius of each of the circular cylinders CS1 and CS2 is the second radius R2.

The ridge line RL of the elongated hole shaped through hole HE includes a circular arc-shaped segment RL1, a straight line-shaped segment RL2, a circular arc-shaped segment RL3, and a straight line-shaped segment RL4. The straight line-shaped segments RL2 and RL4 are parallel to the Y-axis. The circular arc-shaped segment RL1 corresponds to one-half of the circumference forming the side surface of the circular cylinder CS1. The circular arc-shaped segment RL3 corresponds to one-half of the circumference forming the side surface of the circular cylinder CS2. The regions where the two circular cylinders CS1 and CS2 are inserted through the through hole HE are included in both corners (both ends) of the through hole HE.

In FIG. 19, the machining target point P1 is shown at a position on the ridge line RL of the through hole HE where the straight line-shaped segment RL4 and the circular arc-shaped segment RL1 are connected to each other. In FIG. 19, the machining target point P2 is shown at a position on the ridge line RL of the through hole HE where the circular arc-shaped segment RL1 and the straight line-shaped segment RL2 are connected to each other.

In FIG. 19, the machining target point P3 is shown at a position on the ridge line RL of the through hole HE where the straight line-shaped segment RL2 and the circular arc-shaped segment RL3 are connected to each other. In FIG. 19, the machining target point P4 is shown at a position on the ridge line RL of the through hole HE where the circular arc-shaped segment RL3 and the straight line-shaped segment RL4 are connected to each other.

As noted previously, the circular arc-shaped segment RL1 from the machining target point P1 to the machining target point P2 corresponds to the imaginary circular cylinder CS1. Accordingly, the second computation unit 240 calculates the first position C of the tool CI that cuts the circular arc-shaped segment RL1 of the ridge line RL at the predetermined machining width W, in a manner similar to the case of the circular shaped through hole HE that penetrates through the thick-walled cylinder CP shown in FIG. 5A and FIG. 5B.

As noted previously, the circular arc-shaped segment RL3 from the machining target point P3 to the machining target point P4 corresponds to the imaginary circular cylinder CS2. Accordingly, the second computation unit 240 calculates the first position C of the tool CI that cuts the circular arc-shaped segment RL3 of the ridge line RL at the predetermined machining width W, in a manner similar to the case of the circular shaped through hole HE that penetrates through the thick-walled cylinder CP shown in FIG. 5A and FIG. 5B.

More specifically, the second computation unit 240 calculates the first position C of the tool CI in the circular arc-shaped segments RL1 and RL3 of the ridge line RL, based on the machining target data, the second ellipse E2 determined on the basis of the machining target data, the predetermined machining width W, the third radius D of the tool CI, and the first basis vector e1 and the second basis vector e2 on the vertical plane VP. The tool CI, which is disposed at the first position C corresponding to each of the machining target points P within the circular arc-shaped segments RL1 and RL3, cuts the ridge line RL at the predetermined machining width W.

In the three-dimensional coordinate space defined by the X-axis, the Y-axis, and the Z-axis, the three-dimensional coordinate value of the first position C of the tool CI that cuts the ridge line RL at the machining target point P2 at the predetermined machining width W is set to (Xc2, Yc2, Zc2). The machining target point P2 is included in the aforementioned circular arc-shaped segment RL1 within the ridge line RL. The three-dimensional coordinate value of the first position C of the tool CI, which cuts the ridge line RL at the machining target point P3 at the predetermined machining width W is set to (Xc3, Yc3, Zc3). The machining target point P3 is included in the aforementioned circular arc-shaped segment RL3 within the ridge line RL.

As shown in FIG. 19, the straight line-shaped segment RL2 of the ridge line RL extends in the Y-axis direction, and connects between the machining target points P2 and P3. More specifically, the machining target point P2 is at a position obtained by moving the machining target point P3 in the Y-axis direction by the length of the straight line-shaped segment RL2 of the ridge line RL. The first position C of the tool CI corresponding to the machining target point P2 is also positioned at a position obtained by moving the first position C of the tool CI corresponding to the machining target point P3 in the Y-axis direction by the length of the straight line-shaped segment RL2.

Accordingly, the difference between the Y component Yc2 of the three-dimensional coordinate value representing the first position C of the tool CI corresponding to the machining target point P2, and the Y component Yc3 of the three-dimensional coordinate value representing the first position C of the tool CI corresponding to the machining target point P3 corresponds to the length of the straight line-shaped segment RL2 of the ridge line RL. In this manner, the Y components Yc2 and Yc3 are determined.

Moreover, the X component Xc2 and the Z component Zc2 of the three-dimensional coordinate value representing the first position C of the tool CI corresponding to the machining target point P2, respectively, are equal to the X component Xc3 and the Z component Zc3 of the three-dimensional coordinate value representing the first position C of the tool CI corresponding to the machining target point P3. With respect to all the machining target points P on the straight line-shaped segment RL2 of the ridge line RL, the X component and the Z component of the three-dimensional coordinate value representing the first position C of the tool CI are both constant values, and only the Y component changes linearly.

In the three-dimensional coordinate space defined by the X-axis, the Y-axis, and the Z-axis, the three-dimensional coordinate value of the first position C of the tool CI that cuts the ridge line RL at the machining target point P4 at the predetermined machining width W is set to (Xc4, Yc4, Zc4). The machining target point P4 is included in the aforementioned circular arc-shaped segment RL3 on the ridge line RL. The three-dimensional coordinate value of the first position C of the tool CI, which cuts the ridge line RL at the machining target point P1 at the predetermined machining width W, is set to (Xc1, Yc1, Zc1). The machining target point P1 is included in the aforementioned circular arc-shaped segment RL1 on the ridge line RL.

As shown in FIG. 19, the straight line-shaped segment RL4 of the ridge line RL extends in the Y-axis direction, and connects between the machining target points P4 and P1. More specifically, the machining target point P1 is at a position obtained by moving the machining target point P4 in the Y-axis direction by the length of the straight line-shaped segment RL4 of the ridge line RL. The first position C of the tool CI corresponding to the machining target point P1 is also positioned at a position obtained by moving the first position C of the tool CI corresponding to the machining target point P4 in the Y-axis direction by the length of the straight line-shaped segment RL4.

Accordingly, the difference between the Y component Yc1 of the three-dimensional coordinate value representing the first position C of the tool CI corresponding to the machining target point P1, and the Y component Yc4 of the three-dimensional coordinate value representing the first position C of the tool CI corresponding to the machining target point P4 corresponds to the length of the straight line-shaped segment RL4 of the ridge line RL. In this manner, the Y components Yc1 and Yc4 are determined.

Moreover, the X component Xc1 and the Z component Zc1 of the three-dimensional coordinate value representing the first position C of the tool CI corresponding to the machining target point P1, respectively, are equal to the X component Xc4 and the Z component Zc4 of the three-dimensional coordinate value representing the first position C of the tool CI corresponding to the machining target point P4. With respect to all the machining target points P on the straight line-shaped segment RL4 of the ridge line RL, the X component and the Z component of the three-dimensional coordinate value representing the first position C of the tool CI are both constant values, and only the Y component changes linearly.

The first position C of the tool CI corresponding to each of the machining target points P1 and P2 within the circular arc-shaped segment RL1 is calculated in the manner described above. The first position C of the tool CI corresponding to each of the machining target points P3 and P4 within the circular arc-shaped segment RL3 is calculated in the manner described above. The second computation unit 240 calculates the first position C of the tool CI within each of the straight line-shaped segments RL2 and RL4 of the ridge line RL, based on the first positions C of the tool CI corresponding respectively to the machining target points P1, P2, P3 and P4, and the machining target data. As noted previously, the machining target data is acquired by the acquisition unit 210. The tool CI, which is disposed at the first position C corresponding to each of the machining target points P within the straight line-shaped segments RL2 and RL4, cuts the ridge line RL at the predetermined machining width W.

### Exemplary Modification 3

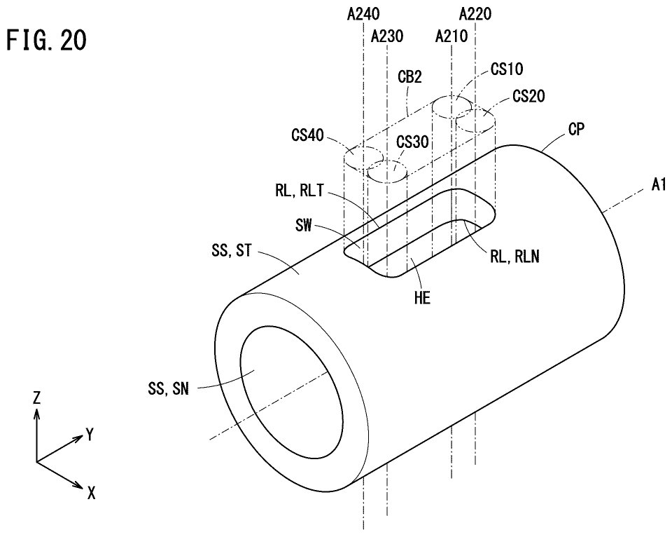

In the above-described Exemplary Modification 2, in the case that the through hole HE that penetrates through the thick-walled cylinder CP is viewed from directly above the through hole HE, the through hole HE is of an elongated hole shape. However, the through hole HE may also be of a rounded rectangular shape. FIG. 20 is a diagram for the purpose of describing the thick-walled cylinder CP and the through hole HE having such a rounded rectangular shape that penetrates through the thick-walled cylinder CP. The ridge line RL of the through hole HE includes four circular arc-shaped segments that form a circular arcuate shape in the case of being viewed from directly above the through hole HE, two straight line-shaped segments that are parallel to the first direction (the direction of the Y-axis), and two straight line-shaped segments that are parallel to the direction of the X-axis.

As noted previously, the first direction is the direction in which the first central axial line A1 of the thick-walled cylinder CP extends. The X-axis direction is perpendicular to the Y-axis direction (the first direction) and the Z-axis direction (the second direction). The four circular arc-shaped segments form the four corners of the through hole HE which is of the rounded rectangular shape of the ridge line RL. These four circular arc-shaped segments are connected, via the aforementioned four straight line-shaped segments, in a manner so as to form the ridge line RL.

The through hole HE having the rounded rectangular shape penetrates, in the shape of an imaginary columnar body CB2 shown in FIG. 20, through the thick-walled cylinder CP from the outer circumferential surface ST to the inner circumferential surface SN of the thick-walled cylinder CP. The columnar body CB2 includes four imaginary parallel circular cylinders CS10, CS20, CS30, and CS40 respectively at the four corners of the columnar body CB2.

The second direction in which each of the central axial line A210 of the circular cylinder CS10, the central axial line A220 of the circular cylinder CS20, the central axial line A230 of the circular cylinder CS30, and the central axial line A240 of the circular cylinder CS40 extend is the Z-axis direction. Accordingly, the central axial lines A210, A220, A230, and A240 are parallel to each other. In the case that the through hole HE is viewed from directly above the through hole HE along the Z-axis, the through hole HE is of a rounded rectangular shape corresponding to the columnar body CB2. The through hole HE is formed by the circumferential wall surface SW.

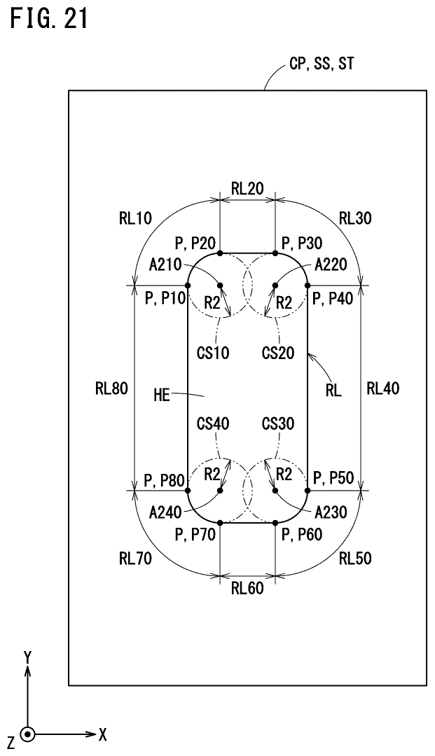

FIG. 21 is a diagram schematically illustrating the through hole HE having the rounded rectangular shape. In FIG. 21, a case is shown in which the thick-walled cylinder CP having the through hole HE of the rounded rectangular shape is viewed from the positive direction of the Z-axis on the outer side of the thick-walled cylinder CP. In FIG. 21, circular bottom surfaces of the four imaginary circular cylinders CS10, CS20, CS30 and CS40 are shown in the through hole HE having the rounded rectangular shape. The radius of the circular cylinder CS10, the radius of the circular cylinder CS20, the radius of the circular cylinder CS30, and the radius of the circular cylinder CS40 are equal to each other. The radius of each of the circular cylinders CS10, CS20, CS30, and CS40 is the second radius R2.

The ridge line RL of the through hole HE having the rounded rectangular shape includes a circular arc-shaped segment RL10, a straight line-shaped segment RL20, a circular arc-shaped segment RL30, a straight line-shaped segment RL40, a circular arc-shaped segment RL50, a straight line-shaped segment RL60, a circular arc-shaped segment RL70, and a straight line-shaped segment RL80. The straight line-shaped segments RL20 and RL60 are parallel to the X-axis. The straight line-shaped segments RL40 and RL80 are parallel to the Y-axis.

The circular arc-shaped segment RL10 corresponds to one fourth of the circumference forming the side surface of the circular cylinder CS10. The circular arc-shaped segment RL30 corresponds to one fourth of the circumference forming the side surface of the circular cylinder CS20. The circular arc-shaped segment RL50 corresponds to one fourth of the circumference forming the side surface of the circular cylinder CS30. The circular arc-shaped segment RL70 corresponds to one fourth of the circumference forming the side surface of the circular cylinder CS40. The regions where the four circular cylinders CS10, CS20, CS30, and CS40 pass respectively through the through hole HE are included in the four corners of the through hole HE.

In FIG. 21, the machining target point P10 is shown at a position on the ridge line RL of the through hole HE where the straight line-shaped segment RL80 and the circular arc-shaped segment RL10 are connected to each other. In FIG. 21, the machining target point P20 is shown at a position on the ridge line RL of the through hole HE where the circular arc-shaped segment RL10 and the straight line-shaped segment RL20 are connected to each other.

In FIG. 21, the machining target point P30 is shown at a position on the ridge line RL of the through hole HE where the straight line-shaped segment RL20 and the circular arc-shaped segment RL30 are connected to each other. In FIG. 21, the machining target point P40 is shown at a position on the ridge line RL of the through hole HE where the circular arc-shaped segment RL30 and the straight line-shaped segment RL40 are connected to each other.

In FIG. 21, the machining target point P50 is shown at a position on the ridge line RL of the through hole HE where the straight line-shaped segment RL40 and the circular arc-shaped segment RL50 are connected to each other. In FIG. 21, the machining target point P60 is shown at a position on the ridge line RL of the through hole HE where the circular arc-shaped segment RL50 and the straight line-shaped segment RL60 are connected to each other.

In FIG. 21, the machining target point P70 is shown at a position on the ridge line RL of the through hole HE where the straight line-shaped segment RL60 and the circular arc-shaped segment RL70 are connected to each other. In FIG. 21, the machining target point P80 is shown at a position on the ridge line RL of the through hole HE where the circular arc-shaped segment RL70 and the straight line-shaped segment RL80 are connected to each other.

As noted previously, the circular arc-shaped segment RL10 from the machining target point P10 to the machining target point P20 corresponds to the imaginary circular cylinder CS10. Accordingly, the second computation unit 240 calculates the first position C of the tool CI that cuts the circular arc-shaped segment RL10 of the ridge line RL at the predetermined machining width W, in a manner similar to the case of the circular shaped through hole HE that penetrates through the thick-walled cylinder CP shown in FIG. 5A and FIG. 5B.

As noted previously, the circular arc-shaped segment RL30 from the machining target point P30 to the machining target point P40 corresponds to the imaginary circular cylinder CS20. Accordingly, the second computation unit 240 calculates the first position C of the tool CI that cuts the circular arc-shaped segment RL30 of the ridge line RL at the predetermined machining width W, in a manner similar to the case of the circular shaped through hole HE that penetrates through the thick-walled cylinder CP shown in FIG. 5A and FIG. 5B.

As noted previously, the circular arc-shaped segment RL50 from the machining target point P50 to the machining target point P60 corresponds to the imaginary circular cylinder CS30. Accordingly, the second computation unit 240 calculates the first position C of the tool CI that cuts the circular arc-shaped segment RL50 of the ridge line RL at the predetermined machining width W, in a manner similar to the case of the circular shaped through hole HE that penetrates through the thick-walled cylinder CP shown in FIG. 5A and FIG. 5B.

As noted previously, the circular arc-shaped segment RL70 from the machining target point P70 to the machining target point P80 corresponds to the imaginary circular cylinder CS40. Accordingly, the second computation unit 240 calculates the first position C of the tool CI that cuts the circular arc-shaped segment RL70 of the ridge line RL at the predetermined machining width W, in a manner similar to the case of the circular shaped through hole HE that penetrates through the thick-walled cylinder CP shown in FIG. 5A and FIG. 5B.

More specifically, the second computation unit 240 calculates the first position C of the tool CI in each of the circular arc-shaped segments RL10, RL30, RL50, and RL70 of the ridge line RL, based on the machining target data, the second ellipse E2 determined on the basis of the machining target data, the predetermined machining width W, the third radius D of the tool CI, and the first basis vector e1 and the second basis vector e2 on the vertical plane VP. The tool CI, which is disposed at the first position C corresponding to each of the machining target points P within the circular arc-shaped segments RL10, RL30, RL50, and RL70 cuts the ridge line RL at the predetermined machining width W.

As shown in FIG. 21, the straight line-shaped segment RL40 of the ridge line RL extends in the Y-axis direction, and connects between the machining target points P40 and P50. More specifically, the machining target point P40 is at a position obtained by moving the machining target point P50 in the Y-axis direction by the length of the straight line-shaped segment RL40 of the ridge line RL. The first position C of the tool CI corresponding to the machining target point P40 is also positioned at a position obtained by moving the first position C of the tool CI corresponding to the machining target point P50 in the Y-axis direction by the length of the straight line-shaped segment RL40. Accordingly, the second computation unit 240 calculates the first position C of the tool CI that cuts the straight line-shaped segment RL40 of the ridge line RL at the predetermined machining width W, in a manner similar to the case of the elongated hole shaped through hole HE that penetrates through the thick-walled cylinder CP shown in FIG. 18 and FIG. 19.

As shown in FIG. 21, the straight line-shaped segment RL80 of the ridge line RL extends in the Y-axis direction, and connects between the machining target points P80 and P10. More specifically, the machining target point P10 is at a position obtained by moving the machining target point P80 in the Y-axis direction by the length of the straight line-shaped segment RL80 of the ridge line RL. The first position C of the tool CI corresponding to the machining target point P10 is also positioned at a position obtained by moving the first position C of the tool CI corresponding to the machining target point P80 in the Y-axis direction by the length of the straight line-shaped segment RL80. Accordingly, the second computation unit 240 calculates the first position C of the tool CI that cuts the straight line-shaped segment RL80 of the ridge line RL at the predetermined machining width W, in a manner similar to the case of the elongated hole shaped through hole HE that penetrates through the thick-walled cylinder CP shown in FIG. 18 and FIG. 19.

The first position C of the tool CI corresponding to the machining target point P10 within the circular arc-shaped segment RL10 is calculated in the manner described above. The first position C of the tool CI corresponding to the machining target point P40 within the circular arc-shaped segment RL30 is also calculated in the manner described above. The first position C of the tool CI corresponding to the machining target point P50 within the circular arc-shaped segment RL50 is also calculated in the manner described above. The first position C of the tool CI corresponding to the machining target point P80 within the circular arc-shaped segment RL70 is also calculated in the manner described above.

The second computation unit 240 calculates the first position C of the tool CI within each of the straight line-shaped segments RL40 and RL80 of the ridge line RL, based on the first positions C of the tool CI corresponding respectively to the machining target points P10, P40, P50 and P80, and the machining target data. As noted previously, the machining target data is acquired by the acquisition unit 210. The tool CI that is disposed at the first position C corresponding to each of the machining target points P within the straight line-shaped segments RL40 and RL80, cuts the ridge line RL at the predetermined machining width W.

In the three-dimensional coordinate space defined by the X-axis, the Y-axis, and the Z-axis, the three-dimensional coordinate value of the first position C of the tool CI that cuts the ridge line RL at the machining target point P20 at the predetermined machining width W is set to (Xc20, Yc20, Zc20). The machining target point P20 is included in the aforementioned circular arc-shaped segment RL10 within the ridge line RL. The three-dimensional coordinate value of the first position C of the tool CI, which cuts the ridge line RL at the machining target point P30 at the predetermined machining width W, is set to (Xc30, Yc30, Zc30). The machining target point P30 is included in the aforementioned circular arc-shaped segment RL30 within the ridge line RL.

As shown in FIG. 21, the straight line-shaped segment RL20 of the ridge line RL extends in the X-axis direction, and connects between the machining target points P20 and P30. More specifically, the machining target point P30 is at a position obtained by moving the machining target point P20 in the X-axis direction by the length of the straight line-shaped segment RL20 of the ridge line RL. The first position C of the tool CI corresponding to the machining target point P30 is also positioned at a position obtained by moving the first position C of the tool CI corresponding to the machining target point P20 in the X-axis direction by the length of the straight line-shaped segment RL20.

Accordingly, the difference between the X component Xc30 of the three-dimensional coordinate value representing the first position C of the tool CI corresponding to the machining target point P30, and the X component Xc20 of the three-dimensional coordinate value representing the first position C of the tool CI corresponding to the machining target point P20 corresponds to the length of the straight line-shaped segment RL20 of the ridge line RL. In this manner, the X components Xc20 and Xc30 are determined.

Moreover, the Y component Yc20 of the three-dimensional coordinate value representing the first position C of the tool CI corresponding to the machining target point P20 is equal to the Y component Yc30 of the three-dimensional coordinate value representing the first position C of the tool CI corresponding to the machining target point P30.

The machining target points P20 and P30 are positioned on the cylindrical circumferential surface SS of the thick-walled cylinder CP. As shown in FIG. 10A, in the case of being viewed from the Y-axis, the cylindrical circumferential surface SS is represented by a circle of the first radius R1 centered on a position, on the XZ plane, of the first central axial line A1 of the thick-walled cylinder CP. The segment RL20, which is a straight line when viewed from the positive direction of the Z-axis, is seen as a portion of an arc of this circle when viewed from the negative direction of the Y-axis. In FIG. 10A, when the two-dimensional coordinate value of the point O, which is the point of intersection between the second central axis A2 and the X-axis, is defined as (0, 0), then the coordinate value of the center position of the circle representing the cylindrical circumferential surface SS is (−f, 0).

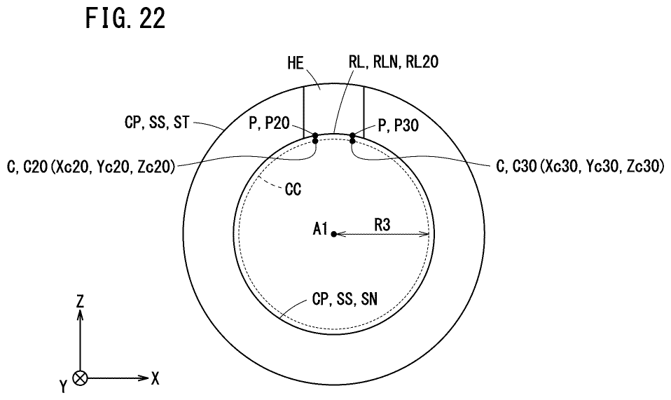

FIG. 22 is a diagram for the purpose of describing the positional relationship between the first position C of the tool CI and the first central axial line A1 of the thick-walled cylinder CP. In FIG. 22, a case is shown in which the thick-walled cylinder CP, which is cut by a plane perpendicular to the Y-axis (a plane parallel to the XZ plane), is viewed from the negative direction of the Y-axis. The tool CI removes the burr BR by cutting at the predetermined machining width the ridge line RL including the machining target point P. From within the ridge line RL that is cut, the segment RL20 from the machining target point P20 to the machining target point P30 is included in the aforementioned circle that represents the cylindrical circumferential surface SS.

Accordingly, the first position C of the tool CI that cuts the ridge line RL within the segment RL20 from the machining target point P20 to the machining target point P30 is on an arc of a circle CC of a radius R3 centered at a position that is equal to the center position (−f, 0) of the circle representing the aforementioned cylindrical circumferential surface SS. The center position (−f, 0) of the circle CC is the position, on the XZ plane, of the first central axial line A1 of the thick-walled cylinder CP. The circle CC is expressed on the XZ plane by Equation (23). The X component and the Z component of the three-dimensional coordinate value representing the first position C of the tool CI that cuts the ridge line RL in the segment RL20 from the machining target point P20 to the machining target point P30 satisfy the Equation (23).

$${( X + f )}^{2} + {Z}^{2} = R {3}^{2} \qquad ( 23 )$$

The X component Xc20 and the Z component Zc20 of the three-dimensional coordinate value representing the first position C20 of the tool CI corresponding to the machining target point P20 also satisfy the Equation (23). The X component Xc30 and the Z component Zc30 of the three-dimensional coordinate value representing the first position C30 of the tool CI corresponding to the machining target point P30 also satisfy the Equation (23). Accordingly, the radius R3 of the aforementioned circle CC is obtained by Equation (24). The radius R3 of the circle CC is equal to the distance between the first position C20 of the tool CI corresponding to the machining target point P20, and the first central axial line A1 of the thick-walled cylinder CP. The radius R3 of the circle CC is also equal to the distance between the first position C30 of the tool CI corresponding to the machining target point P30, and the first central axial line A1 of the thick-walled cylinder CP.

$$\begin{matrix}R 3 = \sqrt{{( Xc 20 + f )}^{2} + Zc {20}^{2}} \\ = \sqrt{{( Xc 30 + f )}^{2} + Zc {30}^{2}}\end{matrix} \qquad ( 24 )$$

Each of the Z components Zc20 and Zc30 is determined by substituting the corresponding one of the aforementioned X components Xc20 and Xc30 of the three-dimensional coordinate value representing the first position C of the tool CI corresponding respectively to the machining target points P20 and P30 into the variable X in the Equation (23).

At any machining target point P on the segment RL20 of the ridge line RL, when the X component of the three-dimensional coordinate value representing the first position C of the tool CI changes, the Y component remains unchanged, and the Z component changes depending on the X component in accordance with the Equation (23). Moreover, in FIG. 22, an example is shown of a case in which the ridge line RL (RLN) forming the edge of the through hole HE is cut by the tool CI in order to remove the burr BR generated on the inner circumferential surface SN of the thick-walled cylinder CP. However, the same is also true in the case in which the ridge line RL forming the edge of the through hole HE is cut by the tool CI in order to remove the burr BR generated on the outer circumferential surface ST of the thick-walled cylinder CP.

In the three-dimensional coordinate space defined by the X-axis, the Y-axis, and the Z-axis, the three-dimensional coordinate value of the first position C of the tool CI that cuts the ridge line RL at the machining target point P60 at the predetermined machining width W is set to (Xc60, Yc60, Zc60). The machining target point P60 is included in the aforementioned circular arc-shaped segment RL50 within the ridge line RL. The three-dimensional coordinate value of the first position C of the tool CI, which cuts the ridge line RL at the machining target point P70 at the predetermined machining width W, is set to (Xc70, Yc70, Zc70). The machining target point P70 is included in the aforementioned circular arc-shaped segment RL70 within the ridge line RL.

As shown in FIG. 21, the straight line-shaped segment RL60 of the ridge line RL extends in the X-axis direction, and connects between the machining target points P60 and P70. More specifically, the machining target point P60 is at a position obtained by moving the machining target point P70 in the X-axis direction by the length of the straight line-shaped segment RL60 of the ridge line RL. The first position C of the tool CI corresponding to the machining target point P60 is also positioned at a position obtained by moving the first position C of the tool CI corresponding to the machining target point P70 in the X-axis direction by the length of the straight line-shaped segment RL60.

Accordingly, the difference between the X component Xc60 of the three-dimensional coordinate value representing the first position C of the tool CI corresponding to the machining target point P60, and the X component Xc70 of the three-dimensional coordinate value representing the first position C of the tool CI corresponding to the machining target point P70 corresponds to the length of the straight line-shaped segment RL60 of the ridge line RL. In this manner, the X components Xc60 and Xc70 are determined.

Moreover, the Y component Yc60 of the three-dimensional coordinate value representing the first position C of the tool CI corresponding to the machining target point P60 is equal to the Y component Yc70 of the three-dimensional coordinate value representing the first position C of the tool CI corresponding to the machining target point P70.

The machining target points P60 and P70 are positioned on the cylindrical circumferential surface SS of the thick-walled cylinder CP. Accordingly, the Equation (23), in which the Z components Zc60 and Zc70 of the three-dimensional coordinate value representing the first position C of the tool CI corresponding to the machining target points P60 and P70 serve as the variable Z, is satisfied. Each of the Z components Zc60 and Zc70 is determined by substituting the corresponding one of the aforementioned X components Xc60 and Xc70 of the three-dimensional coordinate value representing the first position C of the tool CI corresponding respectively to the machining target points P60 and P70 into the variable X in the Equation (23).

At any machining target point P on the segment RL60 of the ridge line RL, when the X component of the three-dimensional coordinate value representing the first position C of the tool CI changes, the Y component remains unchanged, and the Z component changes depending on the X component in accordance with the Equation (23).

The first position C of the tool CI corresponding to the machining target point P20 within the circular arc-shaped segment RL20 is calculated in the manner described above. The first position C of the tool CI corresponding to the machining target point P30 within the circular arc-shaped segment RL30 is also calculated in the manner described above. The first position C of the tool CI corresponding to the machining target point P60 within the circular arc-shaped segment RL50 is also calculated in the manner described above. The first position C of the tool CI corresponding to the machining target point P70 within the circular arc-shaped segment RL70 is also calculated in the manner described above.

The second computation unit 240 calculates the first position C of the tool CI within each of the straight line-shaped segments RL20 and RL60 of the ridge line RL, based on the first positions C of the tool CI corresponding respectively to the machining target points P20, P30, P60, and P70, and the machining target data. As noted previously, the machining target data is acquired by the acquisition unit 210. The tool CI that is disposed at the first position C corresponding to the machining target points P within each of the straight line-shaped segments RL20 and RL60, cuts the ridge line RL at the predetermined machining width W.

### Exemplary Modification 4

The above-described embodiment and the exemplary modifications may be combined optionally.

### Inventions that can be Obtained from the Embodiment

The inventions that can be grasped from the above-described embodiment and the modifications thereof will be described below.

(1) The computation device (110) calculates the first position (C) of the tool (CI) configured to cut the ridge line (RL) at the predetermined machining width (W), the ridge line being formed by the cylindrical circumferential surface (SS) of the workpiece (CP, MB) and the circumferential wall surface (SW) that defines the through hole (HE) penetrating through the workpiece, wherein the workpiece includes the outer circumferential surface (ST) and the inner circumferential surface (SN), at least one of the outer circumferential surface or the inner circumferential surface being formed as the cylindrical circumferential surface, and the through hole penetrates, in the shape of the circular cylinder (CS, CS1, CS2, CS10, CS20, CS30, CS40) or the columnar body (CB1, CB2), through the workpiece from one to another of the outer circumferential surface and the inner circumferential surface, the columnar body containing the plurality of circular cylinders that are parallel to each other and that are disposed respectively in corners of the columnar body. The computation device includes: the acquisition unit (210) configured to acquire machining target data and the third radius (D) of the tool, the machining target data including the second position of the workpiece, the third position of the through hole, the first radius (R1) of the cylindrical circumferential surface of the workpiece, the second radius (R2) of the circular cylinder, the first direction in which the first central axial line (A1) of the workpiece extends, and the eccentric distance (f) of the second central axial line (A2, A21, A22, A210, A220, A230, A240) of the circular cylinder from the first central axial line, the second central axial line extending in the second direction perpendicular to the first direction; the first computation unit (230) configured to calculate the first basis vector (e1) and the second basis vector (e2), based on the machining target data, wherein the first basis vector is a vector on the plane (VP) and perpendicular to the second central axial line, and has, as its starting point, the machining target point (P) that is on the ridge line, and the second basis vector is a vector on the plane and perpendicular to the first basis vector, and has the machining target point as its starting point, and wherein the plane is perpendicular to the tangent line (TL) to the ridge line at the machining target point, the plane includes the machining target point, and the plane is determined based on the fourth position of the machining target point and the machining target data; and the second computation unit (240) configured to calculate the first position of the tool that cuts the ridge line including the machining target point, based on the machining target data, the ellipse (E2) formed by the plane and the circular cylinder and determined based on the machining target data, the predetermined machining width, the third radius of the tool, the first basis vector, and the second basis vector. In accordance with such features, it is possible to accurately calculate the position of the tool that realizes a stable cutting process for the purpose of removing burrs.

(2) The computation device may further include the determination unit (220) configured to determine, when the tolerance amount (TA) in relation to the machining path (RP) corresponding to the ridge line is set by the user, the plurality of machining target points on the ridge line, based on the tolerance amount, wherein the tool cuts the ridge line while moving along the machining path. The first computation unit may calculate the first basis vector and the second basis vector corresponding to each of the plurality of machining target points, and the second computation unit may calculate the first position of the tool corresponding to each of the plurality of machining target points. In accordance with such features, it is possible to realize the cutting process that takes into consideration a balance between the required accuracy of the cutting process, and the computational capability of the computation device.

(3) The second computation unit may calculate the first position of the tool, based on the machining target data, the ellipse, the predetermined machining width, the third radius of the tool, the first basis vector, the second basis vector, and the angle (δ) that the line segment (SL) connecting, on the plane, the first end point (G1) on the cylindrical circumferential surface and the second end point (G2) on the contour line of the ellipse forms with respect to the second basis vector, the distance between the first end point and the second end point being equal to the predetermined machining width. In accordance with such features, it is possible to accurately calculate the position of the tool according to the angle in the machining widthwise direction of the machining surface that is formed by cutting.

(4) In the case that: the first direction is defined as the direction of the Y-axis; the second direction is defined as the direction of the Z-axis that is perpendicular to the direction of the Y-axis; and the third direction perpendicular to both the direction of the Y-axis and the direction of the Z-axis is defined as the direction of the X-axis, the first computation unit may calculate, in a coordinate space defined by the X-axis, the Y-axis, and the Z-axis, the first basis vector e1 and the second basis vector e2, by Equation (8) and Equation (9) which use the first radius R1 of the workpiece, the second radius R2 of the circular cylinder, the eccentric distance f, and the angle ϕ that the perpendicular line from the machining target point to the second central axial line forms with respect to the X-axis; the second computation unit may: calculate the two-dimensional coordinate value (Sc, Tc) of the first position of the tool on the plane, by Equations (12) to (15), Equations (17) to (19), Equation (21), and Equation (22) which use: the first radius R1 of the workpiece; the second radius R2 of the circular cylinder; the eccentric distance f; the predetermined machining width √2·Q; the third radius D of the tool; the first basis vector e1 and the second basis vector e2; the three-dimensional coordinate value (Xp, Yp, Zp) of the fourth position; the angle ε that the second central axial line forms with respect to the plane; and the angle δ that the line segment (SL) connecting the first end point (G1) (S1, T1) and the second end point (G2) (S2, T2) forms with respect to the second basis vector e2, the first end point being on the plane and on the cylindrical circumferential surface, the second end point being on the contour line of the ellipse on the plane, the distance between the first end point (S1, T1) and the second end point (S2, T2) being equal to the predetermined machining width √2·Q; and calculate the three-dimensional coordinate value (Xc, Yc, Zc) of the first position of the tool that cuts the ridge line at the machining target point, by Equation (20), based on the two-dimensional coordinate value (Sc, Tc) of the first position of the tool, the first basis vector e1 and the second basis vector e2, and the three-dimensional coordinate value (Xp, Yp, Zp) of the fourth position of the machining target point obtained by using the machining target data. In accordance with such features, it is possible to accurately calculate the position of the tool according to the angle in the machining widthwise direction of the machining surface that is formed by cutting.

(5) The through hole may penetrate, in the shape of the circular cylinder, through the workpiece, and in the case that the through hole is viewed from directly above the through hole, the through hole may be of a circular shape corresponding to the circular cylinder. In accordance with such features, it is possible to accurately calculate the position of the tool that cuts the ridge line of the circular through hole.

(6) The through hole may penetrate, in the shape of the columnar body, through the workpiece, the columnar body containing two of the circular cylinders parallel to each other and which are disposed respectively in both corners of the columnar body. In the case that the through hole is viewed from directly above the through hole, the through hole may be of the elongated hole shape corresponding to the columnar body. In the case that the through hole is viewed from directly above the through hole, the ridge line of the through hole may include two circular arc-shaped segments (RL1, RL3) corresponding respectively to the two circular cylinders, and two straight line-shaped segments (RL2, RL4) that are in parallel with the first direction. The second computation unit may calculate, based on the machining target data, the ellipse, the predetermined machining width, the third radius of the tool, the first basis vector, and the second basis vector, the first position of the tool corresponding to the machining target point within each of the two circular arc-shaped segments of the ridge line; and the second computation unit may calculate, based on the first position of the tool within each of the two circular arc-shaped segments, and the machining target data, the first position of the tool corresponding to the machining target point within each of the two straight line-shaped segments of the ridge line. In accordance with such features, it is possible to accurately calculate the position of the tool that cuts the ridge line of the elongated through hole.

(7) The through hole may penetrate, in the shape of the columnar body, through the workpiece, the columnar body containing four of the circular cylinders parallel to each other and which are disposed respectively in four corners of the columnar body. In the case that the through hole is viewed from directly above the through hole, the through hole may be of a rounded rectangular shape corresponding to the columnar body. In the case that the through hole is viewed from directly above the through hole, the ridge line of the through hole may include four circular arc-shaped segments (RL10, RL30, RL50, RL70) corresponding respectively to the four circular cylinders, two straight line-shaped segments (RL40, RL80) that are in parallel with the first direction, and other two straight line-shaped segments (RL20, RL60) that are in parallel with a direction perpendicular to the first direction and to the second direction. The second computation unit may calculate, based on the machining target data, the ellipse, the predetermined machining width, the third radius of the tool, the first basis vector, and the second basis vector, the first position of the tool corresponding to the machining target point within each of the four circular arc-shaped segments of the ridge line; and the second computation unit may calculate, based on the first position of the tool within each of the four circular arc-shaped segments and the machining target data, the first position of the tool corresponding to the machining target point within each of the two straight line-shaped segments that are in parallel with the first direction and the other two straight line-shaped segments, of the ridge line. In accordance with such features, it is possible to accurately calculate the position of the tool that cuts the ridge line of a through hole having the rounded rectangular shape.

(8) The acquisition unit may acquire the predetermined machining width based on the user input. In accordance with this feature, the user is capable of setting the machining width of the machining surface that is formed on the ridge line to a value necessary for removing the burrs.

(9) The acquisition unit may acquire the machining target data, the predetermined machining width, and the third radius of the tool, based on the G-code, which indicates a command for calling a macro program (MP) from the storage device (120), the G-code having as an argument at least one of the predetermined machining width, the machining object data, or the number associated with the tool, the second computation unit may read out the macro program from the storage device based on the G-code, and the second computation unit may calculate the first position of the tool by executing the macro program. In accordance with such features, convenience is enhanced for users who are accustomed to cutting the workpiece using the G-code.

(10) The machine tool (10) includes the computation device, the tool, and the machining control unit (250) that causes the tool to move to the first position and causes the tool to cut the ridge line. In accordance with such features, it is possible to realize a stable cutting process for the purpose of removing burrs.

(11) The control device (30) for the machine tool (10) includes the computation device, and the machining control unit (250) that causes the tool to move to the first position and causes the tool to cut the ridge line. In accordance with such features, it is possible to realize a stable cutting process for the purpose of removing burrs.

(12) The computation program causes the processing circuit included in the computation device (110), to perform the acquisition step, the first computation step, and the second computation step, wherein: the computation device is configured to calculate the first position (C) of the tool (CI) configured to cut the ridge line (RL) at the predetermined machining width (W), the ridge line being formed by the cylindrical circumferential surface (SS) of the workpiece (CP, MB) and the circumferential wall surface (SW) that defines the through hole (HE) penetrating through the workpiece; the workpiece includes the outer circumferential surface (ST) and the inner circumferential surface (SN), at least one of the outer circumferential surface or the inner circumferential surface being formed as the cylindrical circumferential surface; and the through hole penetrates, in the shape of the circular cylinder (CS, CS1, CS2, CS10, CS20, CS30, CS40) or the columnar body (CB1, CB2), through the workpiece from one to another of the outer circumferential surface (ST) and the inner circumferential surface, the columnar body containing the plurality of circular cylinders that are parallel to each other and that are disposed respectively in corners of the columnar body, and wherein: the acquisition step includes acquiring the machining target data and the third radius (D) of the tool, the machining target data including the second position of the workpiece, the third position of the through hole, the first radius (R1) of the cylindrical circumferential surface of the workpiece, the second radius (R2) of the circular cylinder, the first direction in which the first central axial line (A1) of the workpiece extends, and the eccentric distance (f) of the second central axial line (A2, A21, A22, A210, A220, A230, A240) of the circular cylinder from the first central axial line, the second central axial line extending in the second direction perpendicular to the first direction; the first computation step includes calculating the first basis vector (e1) and the second basis vector (e2), based on the machining target data, wherein the first basis vector is a vector on the plane (VP) and perpendicular to the second central axial line, and has, as its starting point, the machining target point (P) that is on the ridge line, and the second basis vector is a vector on the plane and perpendicular to the first basis vector, and has the machining target point as its starting point, and wherein the plane is perpendicular to the tangent line (TL) to the ridge line at the machining target point, the plane includes the machining target point, and the plane is determined based on the fourth position of the machining target point and the machining target data; and the second computation step includes calculating the first position of the tool that cuts the ridge line including the machining target point, based on the machining target data, the ellipse (E2) formed by the plane and the circular cylinder and determined based on the machining target data, the predetermined machining width, the third radius of the tool, the first basis vector, and the second basis vector. In accordance with such features, it is possible to accurately calculate the position of the tool that realizes a stable cutting process for the purpose of removing burrs.

### REFERENCE SIGNS LIST

10: machine tool
20: main body
30: control device
52: bed
54: saddle
56: table
74, 76, 78: movable member
110: computation device
120: storage device
130: input/output device
210: acquisition unit
220: determination unit
230: first computation unit
240: second computation unit
250: machining control unit
310: recording medium
320: communication network
330: data signal
340: server

1: A computation device configured to calculate a first position of a tool configured to cut a ridge line at a predetermined machining width, the ridge line being formed by a cylindrical circumferential surface of a workpiece and a circumferential wall surface that defines a through hole penetrating through the workpiece, wherein the workpiece includes an outer circumferential surface and an inner circumferential surface, at least one of the outer circumferential surface or the inner circumferential surface being formed as the cylindrical circumferential surface, and the through hole penetrates, in a shape of a circular cylinder or a columnar body, through the workpiece from one to another of the outer circumferential surface and the inner circumferential surface, the columnar body containing a plurality of the circular cylinders that are parallel to each other and that are disposed respectively in corners of the columnar body, the computation device comprising:
an acquisition unit configured to acquire machining target data and a third radius of the tool, the machining target data including a second position of the workpiece, a third position of the through hole, a first radius of the cylindrical circumferential surface of the workpiece, a second radius of the circular cylinder, a first direction in which a first central axial line of the workpiece extends, and an eccentric distance of a second central axial line of the circular cylinder from the first central axial line, the second central axial line extending in a second direction perpendicular to the first direction;
a first computation unit configured to calculate a first basis vector and a second basis vector, based on the machining target data, wherein the first basis vector is a vector on a plane and perpendicular to the second central axial line, and has, as a starting point, a machining target point that is on the ridge line, and the second basis vector is a vector on the plane and perpendicular to the first basis vector, and has the machining target point as a starting point, and wherein the plane is perpendicular to a tangent line to the ridge line at the machining target point, the plane includes the machining target point, and the plane is determined based on a fourth position of the machining target point and the machining target data; and
a second computation unit configured to calculate the first position of the tool that cuts the ridge line including the machining target point, based on the machining target data, an ellipse formed by the plane and the circular cylinder and determined based on the machining target data, the predetermined machining width, the third radius of the tool, the first basis vector, and the second basis vector.

2: The computation device according to claim 1, further comprising:
a determination unit configured to determine, when a tolerance amount in relation to a machining path corresponding to the ridge line is set by a user, a plurality of the machining target points on the ridge line, based on the tolerance amount, wherein the tool cuts the ridge line while moving along the machining path,
wherein the first computation unit calculates the first basis vector and the second basis vector corresponding to each of the plurality of machining target points; and
the second computation unit calculates the first position of the tool corresponding to each of the plurality of machining target points.

3: The computation device according to claim 1,
wherein the second computation unit calculates the first position of the tool, based on the machining target data, the ellipse, the predetermined machining width, the third radius of the tool, the first basis vector, the second basis vector, and an angle that a line segment connecting, on the plane, a first end point on the cylindrical circumferential surface and a second end point on a contour line of the ellipse forms with respect to the second basis vector, a distance between the first end point and the second end point being equal to the predetermined machining width.

4: The computation device according to claim 1, wherein:
in a case that:
the first direction is defined as a direction of a Y-axis;
the second direction is defined as a direction of a Z-axis that is perpendicular to the direction of the Y-axis; and
a third direction perpendicular to both the direction of the Y-axis and the direction of the Z-axis is defined as a direction of an X-axis,
the first computation unit calculates, in a coordinate space defined by the X-axis, the Y-axis, and the Z-axis, the first basis vector e1 and the second basis vector e2, by a following Equation (1) and a following Equation (2) which use the first radius R1 of the workpiece, the second radius R2 of the circular cylinder, the eccentric distance f, and an angle ϕ that a perpendicular line from the machining target point to the second central axial line forms with respect to the X-axis; and
the second computation unit:
calculates a two-dimensional coordinate value (Sc, Tc) of the first position of the tool on the plane, by following Equations (3) to (9) which use: the first radius R1 of the workpiece; the second radius R2 of the circular cylinder; the eccentric distance f; the predetermined machining width √2·Q; the third radius D of the tool; the first basis vector e1 and the second basis vector e2; a three-dimensional coordinate value (Xp, Yp, Zp) of the fourth position; an angle ε that the second central axial line forms with respect to the plane; and an angle δ that a line segment connecting a first end point (S1, T1) and a second end point (S2, T2) forms with respect to the second basis vector e2, the first end point being on the plane and on the cylindrical circumferential surface, the second end point being on a contour line of the ellipse on the plane, a distance between the first end point (S1, T1) and the second end point (S2, T2) being equal to the predetermined machining width √2·Q; and
calculates a three-dimensional coordinate value (Xc, Yc, Zc) of the first position of the tool corresponding to the machining target point, by a following Equation (10), based on the two-dimensional coordinate value (Sc, Tc) of the first position of the tool, the first basis vector e1 and the second basis vector e2, and the three-dimensional coordinate value (Xp, Yp, Zp) of the fourth position of the machining target point obtained by using the machining target data.
$$\vec{e 1} = ( \begin{matrix}cos ϕ \\ sin ϕ \\ 0\end{matrix} ) \qquad ( 1 )$$
$$\vec{e 2} = ( \begin{matrix}\frac{( R 2 \cdot cos ϕ + f ) {sin}^{2} ϕ}{\sqrt{R {1}^{2} - {( R 2 \cdot cos ϕ + f )}^{2} {cos}^{2} ϕ}} \\ \frac{- ( R 2 \cdot cos ϕ + f ) sin ϕ \cdot cos ϕ}{\sqrt{R {1}^{2} - {( R 2 \cdot cos ϕ + f )}^{2} {cos}^{2} ϕ}} \\ \frac{\sqrt{R {1}^{2} - {( R 2 \cdot cos ϕ + f )}^{2}}}{\sqrt{R {1}^{2} - {( R 2 \cdot cos ϕ + f )}^{2} {cos}^{2} ϕ}}\end{matrix} ) \qquad ( 2 )$$
$$( \begin{matrix}X 1 \\ Y 1 \\ Z 1\end{matrix} ) = ( \begin{matrix}Xp \\ Yp \\ Zp\end{matrix} ) + S 1 \cdot \vec{e 1} + T 1 \cdot \vec{e 2} \qquad ( 3 )$$
$${( X 1 + f )}^{2} + Z {1}^{2} = R {1}^{2} \qquad ( 4 )$$
$$\frac{{( S 2 + R 2 )}^{2}}{R {2}^{2}} + \frac{T {2}^{2}}{{( \frac{R 2}{sin ε} )}^{2}} = 1 \qquad ( 5 )$$
$${( S 1 - S 2 )}^{2} + {( T 1 - T 2 )}^{2} = 2 {Q}^{2} \qquad ( 6 )$$
$$\frac{T 1 - T 2}{S 1 - S 2} = \pm \frac{1}{tan δ} \qquad ( 7 )$$
$$Sc = \frac{S 1 + S 2}{2} - \sqrt{{D}^{2} - \frac{1}{2} {Q}^{2}} \cdot cos δ \qquad ( 8 )$$
$$Tc = \frac{T 1 + T 2}{2} \pm \sqrt{{D}^{2} - \frac{1}{2} {Q}^{2}} \cdot sin δ \qquad ( 9 )$$
$$( \begin{matrix}Xc \\ Yc \\ Z c\end{matrix} ) = ( \begin{matrix}Xp \\ Yp \\ Zp\end{matrix} ) + Sc \cdot \vec{e 1} + Tc \cdot \vec{e 2} \qquad ( 10 )$$

5: The computation device according to claim 1, wherein:
the through hole penetrates, in a shape of the circular cylinder, through the workpiece; and
in a case that the through hole is viewed from directly above the through hole, the through hole is of a circular shape corresponding to the circular cylinder.

6: The computation device according to claim 1, wherein:
the through hole penetrates, in a shape of the columnar body, through the workpiece, the columnar body containing two of the circular cylinders parallel to each other and which are disposed respectively in both corners of the columnar body;
in a case that the through hole is viewed from directly above the through hole, the through hole is of an elongated hole shape corresponding to the columnar body;
in the case that the through hole is viewed from directly above the through hole, the ridge line of the through hole includes two circular arc-shaped segments corresponding respectively to the two circular cylinders, and two straight line-shaped segments that are in parallel with the first direction;
the second computation unit calculates, based on the machining target data, the ellipse, the predetermined machining width, the third radius of the tool, the first basis vector, and the second basis vector, the first position of the tool corresponding to the machining target point within each of the two circular arc-shaped segments of the ridge line; and
the second computation unit calculates, based on the first position of the tool within each of the two circular arc-shaped segments, and the machining target data, the first position of the tool corresponding to the machining target point within each of the two straight line-shaped segments of the ridge line.

7: The computation device according to claim 1, wherein:
the through hole penetrates, in a shape of the columnar body, through the workpiece, the columnar body containing four of the circular cylinders parallel to each other and which are disposed respectively in four corners of the columnar body;
in a case that the through hole is viewed from directly above the through hole, the through hole is of a rounded rectangular shape corresponding to the columnar body;
in the case that the through hole is viewed from directly above the through hole, the ridge line of the through hole includes four circular arc-shaped segments corresponding respectively to the four circular cylinders, two straight line-shaped segments that are in parallel with the first direction, and other two straight line-shaped segments that are in parallel with a direction perpendicular to the first direction and to the second direction;
the second computation unit calculates, based on the machining target data, the ellipse, the predetermined machining width, the third radius of the tool, the first basis vector, and the second basis vector, the first position of the tool corresponding to the machining target point within each of the four circular arc-shaped segments of the ridge line; and
the second computation unit calculates, based on the first position of the tool within each of the four circular arc-shaped segments and the machining target data, the first position of the tool corresponding to the machining target point within each of the two straight line-shaped segments that are in parallel with the first direction and the other two straight line-shaped segments, of the ridge line.

8: The computation device according to claim 1, wherein the acquisition unit acquires the predetermined machining width based on a user input.

9: The computation device according to claim 1, wherein:
the acquisition unit acquires the machining target data, the predetermined machining width, and the third radius of the tool, based on a G-code, which indicates a command for calling a macro program from a storage device, the G-code having as an argument at least one of the predetermined machining width, the machining target data, or a number associated with the tool;
the second computation unit reads out the macro program from the storage device based on the G-code; and
the second computation unit calculates the first position of the tool by executing the macro program.

10: A machine tool comprising:
the computation device according to claim 1;
the tool; and
a machining control unit configured to cause the tool to move to the first position and cause the tool to cut the ridge line.

11: A control device for a machine tool, comprising:
the computation device according to claim 1; and
a machining control unit configured to cause the tool to move to the first position and cause the tool to cut the ridge line.

12: A non-transitory computer-readable storage medium that stores a computation program configured to cause a processing circuit included in a computation device, to perform an acquisition step, a first computation step, and a second computation step,
wherein: the computation device is configured to calculate a first position of a tool configured to cut a ridge line at a predetermined machining width, the ridge line being formed by a cylindrical circumferential surface of a workpiece and a circumferential wall surface that defines a through hole penetrating through the workpiece; the workpiece includes an outer circumferential surface and an inner circumferential surface, at least one of the outer circumferential surface or the inner circumferential surface being formed as the cylindrical circumferential surface; and the through hole penetrates, in a shape of a circular cylinder or a columnar body, through the workpiece from one to another of the outer circumferential surface and the inner circumferential surface, the columnar body containing a plurality of the circular cylinders that are parallel to each other and that are disposed respectively in corners of the columnar body, and
wherein:
the acquisition step comprises acquiring machining target data and a third radius of the tool, the machining target data including a second position of the workpiece, a third position of the through hole, a first radius of the cylindrical circumferential surface of the workpiece, a second radius of the circular cylinder, a first direction in which a first central axial line of the workpiece extends, and an eccentric distance of a second central axial line of the circular cylinder from the first central axial line, the second central axial line extending in a second direction perpendicular to the first direction;
the first computation step comprises calculating a first basis vector and a second basis vector, based on the machining target data, wherein the first basis vector is a vector on a plane and perpendicular to the second central axial line, and has, as a starting point, a machining target point that is on the ridge line, and the second basis vector is a vector on the plane and perpendicular to the first basis vector, and has the machining target point as a starting point, and wherein the plane is perpendicular to a tangent line to the ridge line at the machining target point, the plane includes the machining target point, and the plane is determined based on a fourth position of the machining target point and the machining target data; and
the second computation step comprises calculating the first position of the tool that cuts the ridge line including the machining target point, based on the machining target data, an ellipse formed by the plane and the circular cylinder and determined based on the machining target data, the predetermined machining width, the third radius of the tool, the first basis vector, and the second basis vector.
